(19) United States
(12) Patent Application Publication
(10) Pub. No.: US 2025/0026533 A1
(43) Pub. Date: Jan. 23, 2025

(54) TRAY FOR TRANSPORTING A LOAD IN AN ORDER-PICKING SYSTEM, UNLOADING DEVICE AND LOADING DEVICE

(71) Applicant: TGW Logistics Group GmbH, Marchtrenk (AT)

(72) Inventors: Stefan HOLZNER, Zaisering (DE); Matthias KROPF, Aschau im Chiemgau (DE)

(73) Assignee: TGW Logistics Group GmbH, Marchtrenk (AT)

(21) Appl. No.: 18/715,155

(22) PCT Filed: Dec. 2, 2022
(86) PCT No.: PCT/AT2022/060425

§ 371 Date: May 31, 2024

(30) Foreign Application Priority Data
Dec. 2, 2021 (AT) A50965/2021

(51) Int. Cl. B65D 19/18; B65D 19/00; B65D 83/00; B65G 47/82

(52) U.S. Cl. CPC B65D 19/18; B65D 19/0002; B65D 83/0005; B65G 47/82; B65D 2519/00805; B65G 2201/0258; B65G 2207/46

(57) ABSTRACT

A multi-part tray for transporting a load in an order-picking system includes four side walls, a lower part and an upper part movable relative to the lower part from a transport configuration into a transferring configuration. The lower part provides two first side walls and the upper part provides two second side walls. Furthermore, with an unloading device and a method for unloading the tray, the upper part is moved relative to the lower part in order to move the tray from the transport configuration into the transferring configuration. Further, a computer-implemented method controls a position changing device in order to bring a load into a loading pose for loading a tray. In addition, a loading device carries out the method. Finally, an order-picking system has trays, an unloading device and/or a loading device.

The invention relates to a tray for transporting a load in an order-picking system having four side walls, a lower part, which comprises a transport base, and an upper part, which comprises a loading base for receiving a load and which is mounted movably on the lower part in relation to the transport base,
wherein the transport base comprises an upper side facing the upper part, a lower side facing away from the upper part, and a transport surface on the lower side, and the loading base comprises a lower side facing the lower part, an upper side facing away from the lower part, and a first loading plane on the upper side, and
wherein the tray has a transport configuration in which the loading base is arranged in a lower transport position and the load is positionable between the side walls, and a transferring configuration in which the loading base is arranged in an upper transferring position and the load can be pushed from the loading base.

Furthermore, the invention relates to an unloading device for unloading a tray loaded with a load. The tray comprises four side walls, a lower part with a transport base and an upper part with a loading base for receiving a load and which is mounted movably on the lower part in relation to the transport base, wherein the tray has a transport configuration in which the loading base is arranged in a lower transport position and the load is positionable between the side walls, and a transferring configuration in which the loading base is arranged in an upper transferring position and the load can be pushed from the loading base. The unloading device comprises a provisioning location for providing the tray, a transfer location for taking over the load from the tray which adjoins the provisioning location, a tray conveying system comprising an automated tray conveying device for transporting the tray to the provisioning location and for transporting the tray away from the provisioning location, which defines a tray conveying plane, a load conveying system comprising an automated load conveying device for transporting the load away from the transfer location, which defines a load conveying plane, a positioning system for the positioning of the tray in a provisioning position at the provisioning location, an actuating device for performing a relative movement between the upper part and the lower part of the tray to bring the tray out of the transport configuration and into the transferring configuration, wherein the actuating device is arranged in the region of the provisioning location, a transfer device for pushing the load from the tray onto the transfer location when the tray is at the provisioning location (in the provisioning position) and is provided in the transferring configuration, wherein the transfer device is arranged in the region of the provisioning location.

Moreover, the invention relates to a method for unloading a tray loaded with a load which comprises four side walls, a lower part with a transport base and an upper part with a loading base for receiving a load, wherein the upper part is mounted movably on the lower part in relation to the transport base and wherein the tray has a transport configuration in which the loading base is arranged in a lower transport position and the load is positionable between the side walls, and a transferring configuration in which the loading base is arranged in an upper transferring position and the load can be pushed from the loading base, comprising the steps:
transporting the tray to a provisioning location by a tray conveying system on a tray conveying plane, positioning the tray in a provisioning position at the provisioning location by a positioning system,
moving the tray from the transport configuration into the transferring configuration by an actuating device by performing a relative movement between the upper part and the lower part of the tray,
pushing the load from the loading base to a transfer location by a transfer device,
transporting the load away from the transfer location by a load conveying system on a load conveying plane,
moving the tray from the transferring configuration into the transport configuration by the actuating device,
transporting of the tray away from the provisioning location by the tray conveying system.

Furthermore, the invention relates to a computer-implemented method for controlling a position changing device for changing a pose of a load and for the situational positioning of the load by a control device.

In addition, the invention relates to a loading device for loading a tray with a load, wherein the tray comprises a first receiving compartment which forms a first loading plane at a first height level and is designed with a (first) loading width, wherein the loading device comprises
a transfer system for transferring the load onto the tray, a load conveying system for transporting the load to the transfer system,
a tray conveying system for transporting to and providing the tray at the transfer system,
a position changing device for changing a pose of the load and for the situational positioning of the load which is arranged along the load conveying system, and
a control device, which controls the position changing device to change a pose of the load and the situational positioning of the load,
and wherein the transfer system is configured for receiving the load from the load conveying system and for transferring the load onto the tray provided by the tray conveying system.

Finally, the invention relates to an order-picking system for storing and picking a load, comprising a plurality of trays for transporting a load in the order-picking system,
a loading device for (automatically) loading a tray with a load or several loads, an automatically operated tray storage for storing loads on the trays,
a first conveying device between the loading device and the tray storage to (automatically) transport the trays after loading by the loading device to the tray storage,
an unloading device for (automatically) unloading a tray which is loaded with a load or several loads,
a second conveying device between the tray storage and the unloading device to transport the trays from the tray storage to the unloading device, and
an order-picking device for (automatically or manually) loading an order load carrier with loads which were unloaded from the trays at the unloading device.

Order-picking systems with one-piece or multi-piece trays are known in the art.

For instance, a one-piece tray is known from WO 2019/140473 A1 which has a base and four side walls extending from the base. A lower side of the base thereby provides a transport surface. An upper side of the base provides a first and potentially second loading plane which serves to receive a load. For unloading, this tray further has a pusher ramp which bridges or reduces a height difference between the loading plane and an upper edge of a side wall. Moreover, an unloading device is known from WO 2019/140473 A1 which has a pusher for pushing the load over the pusher ramp. The pusher ramps do indeed facilitate the automatic pushing the load from the tray, but the transport safety of the load on the tray is no longer guaranteed because the load can slip and even fall off the tray due to vibrations during transportation.

A one-piece tray is also known from EP 1 462 393 A1 which has a base and four side walls extending from the base. Here again, the lower side of the base provides a transport surface and the upper side a loading plane for receiving a load. It is thereby provided that the base has a plurality of engagement openings which enable lift pins of an unloading device to pass through them. The load can thereby be lifted from the base by means of the lift pins and subsequently be pushed off the lift pins by a pusher. The disadvantage there is, however, that the lift pins define a substantially “interrupted” surface upon which a packing unit (load) or its packaging can be snagged.

Furthermore, a multi-piece tray is known from WO 2010/060745 A1 which comprises a lower part and an upper part. The lower part has a transport base and four side walls extending from the transport base. The upper part is configured as a shelf which is mounted movably within the lower part and provides a loading plane for receiving a load. The shelf can thereby be moved from a lower transport position in which the loading base rests on top of the transport base into an upper transferring position in which the load can be pushed from the loading base. To bring the loading base from the transport position to the transferring position, the lower part can be lowered while the loading base is supported from below. For this purpose, the transport base has a large engagement opening through which one or more support means can extend.

Moreover, various embodiments of loading devices are known in the art for automatically loading a tray with a load. The load is usually thereby provided at the loading device and dispensed onto the tray via a conveying device, as described in WO 2009/143340 A2, for example. As a rule, no emphasis is placed on an exact alignment and/or position of the load on the tray, particularly as it is very likely to change due to vibrations during the transportation of the tray.

One object of the invention is to provide an improved tray, an improved unloading device, and a method for unloading of the type mentioned at the beginning. In particular, automatic unloading of the tray shall be enabled.

A further object of the invention is to provide an improved method for controlling a position changing device of a loading device and an improved loading device for loading a tray of the type mentioned at the beginning. In particular, automatic loading of a tray with a load ought to be reliably possible.

Finally, an object of the invention is to provide an improved order-picking system of the type mentioned at the beginning. In particular, automatic handling of each individual tray ought to be enabled.

The object of the invention is solved in a tray of the type mentioned at the beginning in that the lower part comprises two of the four side walls, which form first side walls and project upwards from the transport base, and the upper part comprises two of the four side walls which form second side walls and project upwards from the loading base.

One particular advantage of the invention is that the load can be pushed from the loading base at an open side of the tray when the tray is in the transferring configuration. The side walls or loading base thereby allow for automated relative movement to be performed between the upper part and the lower part, by means of which automatic unloading can be achieved. The two side walls can thus, for example, be gripped from above by support elements, such as gripping means, or be supported from below by support elements, and the upper part be lifted by moving the support elements. Furthermore, the two side walls give the loading base increased stability and rigidity. The loading base can thus be configured in a particularly thin and material-saving fashion.

The tray usually comprises two opposite end sides running parallel to one another and two opposite longitudinal sides running parallel to one another. In an especially preferred embodiment, the longitudinal sides each extend between the end sides and are aligned orthogonally thereto.

The tray can preferably be handled individually.

The tray, in particular the lower part and/or the upper part, is advantageously fashioned from a plastic, preferably injection molded. A preferred temperature range for using the tray can be between −30° C. and +40° C.

The tray, in particular a transport surface of the tray, is suitable to be transported on an automated conveying device and to be set aside in storage bays in warehouse shelves of an automated tray storage (automated storage and retrieval system).

The conveying device can comprise a floor conveying device, for example a roller conveyor, or a belt conveyor. These are each stationary conveying devices. Alternatively or additionally, the conveying device can have a mobile conveying device, which in particular comprises autonomously drivable conveyor vehicles. Such conveyor vehicles can be controlled by a superordinate master computer. Such conveyor vehicles are known to the skilled person under the terms “Automated Guided Vehicle” (short: AGV) or “autonomous mobile robots” (short: AMR).

The transport configuration is the configuration in which the tray is configured for transportation on the conveying device and/or for storage in the automated tray storage. The transferring configuration is the configuration in which the tray is configured at short notice for an unloading of the tray, such as by an unloading device.

Advantageously, the loading base is positioned in the lower transport position at a first distance to the transport base and in the upper transferring position at a second distance to the transport base, where the second distance is greater than the first. It is particularly preferable in the transport position for the loading base to rest, in particular at least partially, on the transport base. The first distance can thus also, at least partially, be zero millimeters.

It can thereby particularly be provided that the loading base rests on the transport base in (small) support regions spaced apart from one another, where in particular outside the support regions a gap is present between the transport base and the loading base. For this purpose, several support nipples or similar can be arranged, for example, on the lower side of the loading base and/or on the upper side of the transport base. Noise development during transportation of the tray on the conveying device can thereby be reduced. It is, however, of course also conceivable that the loading base rests fully on the transport base.

It is favorable if the tray has an inner space which is limited to the bottom by the loading base and laterally in the transport configuration by the four side walls. In the transferring configuration, the inner space is preferably limited laterally by the two side walls and is open along at least one side, in particular along one end side and/or along one longitudinal side.

It is advantageous if the first loading plane is configured to receive a (single) load and/or to receive several loads. The loads can thereby be placed in a row behind one another on the loading plane.

To center the upper part on the lower part, it can also additionally be provided that the transport base has first centering means on the upper side and the loading base has second centering means on the lower side which mutually interlock in the transport position.

The load which is transported or stored on the tray can, for example, be a container or packing unit, in particular a single item or a group of single items, or similar. If several loads are loaded onto a shared tray and/or are transported or stored thereupon, these loads form a load group.

It is advantageously provided that the first side walls are opposite one another and are arranged in parallel at a mutual distance to one another and/or the second side walls are arranged in parallel at a mutual distance to one another. It is thus achieved that the transport base and/or the loading base are each stabilized along one side by the respective side walls. Furthermore, it is achieved that the loading plane is laterally limited, in particular along the longitudinal sides, by the second side walls and is open between the second side walls, in particular along the end sides.

It is thereby expedient if the second side walls are aligned orthogonally to the first side walls. It is particularly preferable for the first side walls to extend along the end sides and the second side walls to extend along the longitudinal sides of the tray, or vice versa. When viewing the longitudinal side of the tray from the side, the lower part is thereby U-shaped and when viewing the end side of the tray from the side the upper part of the tray is U-shaped, or vice versa.

It is favorable if the first side walls comprise a front portion which extends along the end side of the tray, a first longitudinal portion which orthogonally adjoins a first end of the end side and extends along a first longitudinal side of the tray, a second longitudinal portion which orthogonally adjoins a second end of the front portion which is opposite the first end of the front portion and which extends along a second longitudinal side of the tray which is opposite the first longitudinal side of the tray, wherein the two side walls each extend between two longitudinal portions, in particular when the tray is in the transport configuration. The first side walls thus each form two corners of the tray. Increased stability of the corners of the tray and increased stability and rigidity of the transport base in its corner regions are thereby achieved.

Furthermore, it can be provided that the end side has one or more engagement openings and the longitudinal portions each have one or more engagement openings for gripping means of a stacking machine. It is thereby guaranteed that the tray can be reliably handled by the stacking machine either by the gripping means engaging on the end sides as well as by the gripping means engaging on the longitudinal sides.

Advantageously, the first longitudinal portion and the second longitudinal portion each have a first inclined surface on their respective front end which form an angle α with a plane parallel to the transport base. The angle α is preferably at least 90°, in particular between 90° and 180°, preferably between 120° and 135°, particularly preferably approximately 130°.

Similarly, it can be provided that the second side walls each have second inclined surfaces on their front ends which form an angle β with a plane parallel to the loading base, for example the loading plane. The angle β is preferably maximum 90°, in particular between 0° and 90°, preferably between 45° and 60°, particularly preferably approximately 50°.

It is expedient if the angles α and β are selected such that they amount to 180°. It can thereby be achieved that the second inclined surfaces in the transport configuration each rest, in particular at least partially, on a first front surface.

Optionally, the first inclined surfaces and the second inclined surfaces are each configured with mutually interlocking undercuts to potentially provide a guideway for the upper part.

It is also advantageous for the first side walls to adjoin one another and form a right angle and for the second side walls to adjoin one another and form a right angle. The first side walls thus form a corner of the lower part, whereby the transport base is stabilized in the respective corner region. Analogously, the second side walls form a corner of the upper part, whereby the loading base is stabilized in the respective corner region.

A first side wall of the first side walls is thereby preferably arranged along a first end side of the tray and a second side wall of the first side walls is arranged along a first longitudinal side abutting said end side. Similarly, a first side wall of the second side walls is preferably arranged along a second end side of the tray and a second side wall of the second side walls is arranged along a second longitudinal side abutting said end side. It is thereby achieved that the loading plane is, when viewed from above, substantially limited in an L shape by the second side walls and open on the remaining sides.

To enable improved pushing of the load from the tray, it is advantageous if in the transferring position the loading base is aligned flush, in particular at least partially, with an upper edge of the first side walls, in particular with upper edges of the two first side walls, and/or, in particular partially, projects at an upper edge of the first side walls, in particular at upper edges of the two first side walls.

It can thereby be provided that the loading base has a first loading edge which, in the transferring position, is aligned substantially flush with one of the second side walls. Moreover, it can be provided that the loading base has a second loading edge which, in the transferring position, is aligned substantially flush with the other of the second side walls. The first loading edge and the second loading edge are preferably arranged at opposite ends of the loading base and run parallel to one another, in particular at the end sides of the tray.

It can further be provided that the first side walls each have an inclined surface at the upper edge which runs upwardly from a lower end of the inclined surface on an inner side of the lower part to an upper end of the inclined surface on an outer side of the lower part, thus forming a pusher ramp. In the transferring position, the loading base can thereby be arranged substantially flush with the upper edge in an extension of the inclined surface.

Alternatively, the first and second loading edge can form an angle of 90°, whereby the first loading edge is arranged along an end side and the second loading edge along a longitudinal side of the tray. This is particularly conducive in an embodiment of the tray in which the first side walls form an angle of 90° and/or the second side walls form an angle of 90°.

It is advantageous if the loading base has a pusher ramp on the upper side extending upwardly from the first loading plane. The pushing of a load can thereby be further simplified. It is thereby favorable if the pusher ramp runs from the first loading plane to the first loading edge. Furthermore, a further pusher ramp extending upwardly from the first loading plane can be provided which runs from the first loading plane to the second loading edge.

It is also advantageous if the transport base has a first transport base edge aligned orthogonally to the first side walls and a second transport base edge aligned orthogonally to the first side walls, whereby the upper part projects with a first contact surface beyond the first transport base edge and with a second contact surface beyond the second transport base edge. Support elements of an unloading device can, for instance, thus be contacted from below on the respective contact surfaces to lift the upper part from the transport position into the transferring position, or to fix the upper part while the lower part is lowered to move the tray from the transport configuration into the transferring configuration. It is thereby advantageous that no access or engagement openings are necessary to enable lifting of the upper part. The first contact surface and the second contact surface are hereby preferably provided by the lower side of the loading base.

According to a first embodiment, the transport base edges are arranged running opposite and parallel to one another, in particular along a longitudinal side of the tray.

According to an alternative embodiment, a first transport base edge of the transport base edges is arranged along an end side and a second transport base edge of the transport base edges along a longitudinal side of the tray. The first transport base edge and the second transport base edge hereby form an angle of approximately 90°.

It is favorable if the lower part has first guide elements and the upper part has second guide elements, in particular which interact with the first guide elements, wherein the first and second guide elements mutually interlock to guide the upper part during a movement relative to the lower part. It is thereby favorable if the first guide elements are arranged on or in the second side walls and the second guide elements on or in the loading base. The first guide elements are preferably configured as a guide groove and the second guide elements as a guide projection engaging with the respective guide groove, or vice versa.

It can be provided that the lower part has first securing elements and the upper part has second securing elements, wherein the first and second securing elements mutually interlock and the first securing elements each provide a stop for the second securing elements to limit a movement of the upper part relative to the lower part. It is thereby ensured that the upper part is not (unintentionally) released from the lower part, thereby achieving loss protection.

It can further be provided that the first guide elements (additionally) provide a corresponding stop for the second guide elements.

Furthermore, it can be provided that the upper part is (additionally) guided analogously to the guide elements by the securing elements.

It is further favorable if the lower part and/or the upper part has/have several first stacking elements and several second stacking elements corresponding to the first stacking elements. In particular, the several first stacking elements and the several second stacking elements corresponding to the first stacking elements can be arranged in the region of the first side walls and/or second side walls. A mutual positional fixing of trays stacked one upon the other can thereby be achieved. The first and second stacking elements are thereby configured such that the first stacking elements of a first tray interact with the second stacking elements of a second tray if the second tray is stacked upon the first tray. The first stacking elements of the first tray and the second stacking elements of the second tray can thereby mutually interlock.

Preferably, the first stacking elements can be formed as stacking recesses on an upper edge of the first side walls and/or of the second side walls, or vice versa. Correspondingly, the second stacking elements can be configured as stacking lugs, which complement the stacking recesses, on the lower side of the tray, in particular on the lower side of the transport base, on the lower side of the loading base, on a lower side of the first side walls and/or on a lower side of the second side walls, or vice versa.

It is further favorable if the transport base has a third transport base edge aligned in parallel to the first side walls and a fourth transport base edge aligned in parallel to the first side walls, wherein the lower part forms a third contact surface projecting beyond the third transport base edge and a fourth contact surface projecting beyond the fourth transport base edge. It can hereby be provided that the first, second, third and fourth transport base edges are spaced apart from one another in such a way that the transport base of a second tray can be received at least partially between the first side walls and the second side walls of a first tray if the second tray is stacked upon the first tray. The second tray can thereby rest with its first and second contact surfaces on the second side walls of the first tray and with the third and fourth contact surfaces on the first side walls of the first tray. It is favorable if a distance between the first and second transport base edge substantially equates to an inner distance between the second side walls and a distance between the third and fourth transport base edge substantially equates to an inner distance between the first side walls.

It is advantageous if the transport base has on its lower side a recess recessed from the transport surface (in the direction facing the upper side of the transport base). In the region of the recess, the transport base is thus not resting on the conveying device when the tray is transported on the conveying device, by which increased smoothness can be achieved when transporting the tray. To achieve particularly high smoothness, a width of the recess at its widest point equates at least to half the width of the tray, preferably approximately two thirds of the width of the tray, and/or a length of the recess at its longest point equates at least to half the length of the tray, preferably approximately two thirds of the length of the tray. The recess is formed in particular by a central surface recessed from the transport surface in the direction of the upper side.

It is advantageously provided that the loading base has on its lower side a recess recessed in the direction facing the upper side of the loading base. Upward bending of the edges of the loading base can thereby be reduced if the loading base is subjected to a (heavy) weight of a load. Here again, it can be provided that a width of the recess at its widest point equates at least to half the width of the tray, preferably approximately two thirds of the width of the tray, and/or that a length of the recess at its longest point equates at least to half the length of the tray, preferably approximately two thirds of the length of the tray.

To give the lower part increased rigidity, it is preferably provided that the lower part has on the upper side of the (first) transport base an inner surface and on its lower side an outer surface, with upper stiffening ribs projecting (upwards) from the inner surface distributed across the inner surface and/or lower stiffening ribs projecting (downwards) from the outer surface distributed across the outer surface.

Alternatively or additionally, it can be provided that the transport base comprises a lower base and, arranged in parallel and preferably congruent thereto, an upper base, wherein the lower part has several upper stiffening ribs which are received between the lower base and the upper base.

Furthermore, it can be provided that the transport base has a cover which is attached to the lower side such that the lower stiffening ribs are arranged between the lower base and the cover.

Moreover, it is advantageous if the upper part has an outer surface on the lower side of the loading base and has lower stiffening ribs distributed across the outer surface and projecting (downwards) from the outer surface. It can be favorable if the lower stiffening ribs of the upper parts and the upper stiffening rips of the lower part are arranged such that they are, in particular in the transport configuration and/or in the transferring position, facing one another. It is particularly preferable for the lower stiffening ribs of the upper part and the upper stiffening ribs of the lower part to be arranged flush with one another.

In a preferred embodiment, it is provided that the lower stiffening ribs of the upper part rest on the upper stiffening ribs of the lower part when the loading base is in the transport position. The aforementioned support regions are thus configured by the lower stiffening ribs of the upper part and the upper stiffening ribs of the lower part.

It is favorable if the loading base has a lower base and, arranged in parallel and preferably congruent thereto, an upper base, wherein the upper part has several lower stiffening ribs which are received between the lower base and the upper base.

It is preferably provided that the lower base of the loading base in the transport configuration of the tray rests on the upper base of the transport base. Increased smoothness of the tray is thereby achieved.

To further achieve increased smoothness of the tray during transportation on the conveying device, it can be provided that the transport base has a circumferential transport bevel on the lower side. The transport bevel thereby preferably runs along a circumferential edge of the transport base and is inclined towards the circumferential edge in the direction of the upper side of the transport base.

According to a preferred embodiment it is provided that the loading base forms the first loading level at a first height and a second loading level at a second height, wherein the first loading level is limited in a first loading width by first stop edges running parallel to one another and aligned vertically to the first loading level and wherein the second loading level is limited in a second loading width by second stop edges running parallel to one another and aligned vertically to the second loading level and wherein the second loading width is greater than the first loading width.

A rotational movement of a load which is positioned on the first loading plane can be limited by the first stop edges, in particular if a diagonal of a contact surface of the load is greater than a distance between the stop edges. The second loading plane is provided to receive a larger load which does not, for instance, fit between the first stop edges. A rotational movement of a load can also be limited on the second loading plane by the second stop edges.

The second stop edges are preferably provided by the second side walls.

To further reduce a rotational movement, the first loading plane and/or the second loading plane can be configured with a slip-reducing surface. The surface can thereby have a slip-reducing structure or coating, for instance a rubber coating.

Furthermore, a further loading plane which is limited by further stop edges in the same way can be provided at a further height level. The further height level is thereby arranged between the first height level and the second height level. Naturally, any number of further loading planes can be provided. With increasing height level it is thereby provided that the respective loading planes are also configured with a greater loading width, wherein the first or lowest loading plane is configured with the smallest loading width and the second or uppermost loading plane with the largest loading width.

It is advantageously provided that lower drainage openings are arranged in the transport base, upper drainage openings in the loading base, and/or lateral drainage openings in the first side walls and/or in the second side walls. It is thus possible for liquids to flow out of the tray. This can, for example, be favorable for the draining of extinguisher fluid in case of fire, to not exceed a maximum carrying weight of the tray or to protect the load from longer periods of exposure to liquids.

It is particularly preferably for the lower drainage openings and the upper drainage openings, in particular in the transport configuration and/or in the transferring configuration, to be aligned flush with one another.

It is favorable if the loading base has a plurality of openings extending through the loading base and the transport base a plurality of projections extending into the openings. To limit a movement of the load relative to the tray, in particular during transportation, it is thereby provided that the projections project beyond the first loading plane in the transport configuration of the tray. So that the load can be pushed from the tray during unloading, it is further provided that the projections do not project beyond the first loading plane in the transferring configuration, that is to say they are flush with the first loading plan or are recessed in the direction of the transport base.

Alternatively, the projections can be designed with a friction-increasing coating on an upper end and be dimensioned in such a way that the projections project beyond the first loading plane in the transport configuration or are flush with it. It is thereby expedient if, in the transferring configuration, the projections are recessed in the direction of the transport base.

To provide storage positions arranged behind one another in the longitudinal direction of the tray and to limit the movement of the load relative to the tray in the longitudinal direction of the tray, it is preferably provided that several openings of the openings and several projections of the projections are arranged in a first row and preferably several openings of the openings and several projections of the projections in a second row, wherein the first row/and or the second row are aligned orthogonally to the second side walls.

The further object is solved with an unloading device of the type mentioned at the beginning, wherein the actuating device has a first support element for receiving the upper part in a first edge region of the upper part, a second support element for receiving the upper part in a second edge region of the upper part, and a third support element for receiving the lower part, wherein the first and second support elements for receiving the upper part and the support element for receiving the lower part are movable relatively to one another to provide the tray in the transferring configuration.

A particular advantage achieved with the unloading device is that the tray can be automatically transported and automatically unloaded. The unloading device preferably comprises a tray.

The tray conveying device is preferably configured to transport the tray in a tray conveying device and comprises a first tray conveying section leading to a provisioning location, a second tray conveying section for providing the tray at the provisioning location, and a third tray conveying section leading away from the provisioning location.

In a preferred embodiment, the first tray conveying section and the second tray conveying section as well as the second tray conveying section and the third tray conveying section each form an angle of 90°, such that the tray is substantially transported along a U-shaped path through the unloading device. Naturally, any angles are possible between the individual directions of the tray conveying device. The second tray conveying section can thereby be substantially connected with the first tray conveying section and the third tray conveying section with the second conveying portion by a corner transfer unit or curved conveyor.

According to an alternative embodiment, the first tray conveying section and the second tray conveying section as well as the second tray conveying section and the third tray conveying section each form an angle of 180°, such that a substantially straight transportation of the tray is achieved. The tray conveying sections can thereby directly adjoin with one another.

The tray conveying device can, in particular and as previously described, be configured as a stationary conveying device or as a mobile conveying device.

It is advantageous if the provisioning location is arranged along the tray conveying system. It is particularly preferably for the tray conveying system to comprise the provisioning location, wherein this is preferably configured by a storage location on the tray conveying device, in particular in the second tray conveying section.

The transfer location is arranged adjacent to the provisioning location. Preferably the load conveying system comprises the transfer location, wherein this is particularly configured by a storage location of the load conveying device.

The load can be transported away from the transfer location by means of the load conveying device. The load conveying device is thus preferably configured to transport a load in a load conveying direction. In the region of the transfer location, the load conveying direction is preferably aligned orthogonally to the tray conveying direction and leads away from the transfer location. The load conveying device can, in particular and as previously described, be configured as a stationary conveying device or as a mobile conveying device.

The tray can be provided by the positioning system in front of the transfer location in the service position at the provisioning location. In the service position, the tray can, on the one hand, be aligned with the longitudinal axis orthogonal to the tray conveying device and/or orthogonal to a pushing surface of the transfer device, and on the other hand the longitudinal axis can be centered in the center of the provisioning location. It can thus be ensured that the load or several loads which form a load group can be pushed from the tray without rotation in a pushing direction. If (optional) various loading planes are provided, lateral guiding of a single load or of the loads is achieved during the pushing movement.

For this purpose, the positioning system can have a stop element, movable by a drive device, between an output position, located in particular beneath the tray conveying plane, and a positioning position, located in particular above the tray conveying plane. The stop element is, for example, a stop plate. The stop element preferably comprises a first stop surface and a second stop surface, wherein the tray can be positioned in particular with the first longitudinal portion of a side wall of the first side walls against the first stop surface and with the first longitudinal portion of the other side wall of the first side walls against the second stop surface when the stop element is in the positioning position.

Alternatively, the positioning system can be provided by the tray conveying device if the conveying element or the conveying elements of the tray conveying device are controlled in such a way that the tray is provided in the provisioning position. It can prove advantageous for the conveying element or the conveying elements to be blocked by a brake when the tray is provided in the provisioning position. Equally, the positioning system can be provided by the actuating device as described in the following.

The actuating device is configured to perform the relative movement between the lower part and the upper part of the tray to move the tray from the transport configuration into the transferring configuration and vice versa. Moreover, the first support element and the second support element are arranged such that the upper part can be received in an edge region, in particular on the second side walls or along a longitudinal edge of the loading base, in particular below the second side walls.

According to a first embodiment, the actuating device is equipped to lift the upper part of the tray whilst simultaneously supporting the lower part. For this purpose, the support elements can be configured to support the upper part from below and to lift it by means of a vertical movement relative to the tray conveying plane. On the other hand, the first and second support elements can, for example, comprise movable gripping elements which can grip and lift the second side walls of the upper part. The gripping elements can thereby be configured as clamping gripping elements which clamp the second side walls, or, for example, as positive locking gripping elements which engage in recesses in the second side walls.

According to a second embodiment, the actuating device is equipped to lift the lower part of the tray whilst simultaneously supporting the upper part. For this purpose, the third support element or the tray conveying device can, for example, be lowerable beneath the tray conveying plane. The upper part can be held or fixed during the lowering of the lower part by the first support element and the second support element.

According to a third embodiment, the operating principles of the first and second embodiment are combined, whereby the actuating device is configured to lower the lower part of the tray and simultaneously lift the upper part of the tray.

The third support element is provided in particular by the tray conveying device.

Furthermore, the actuating device can have (additional) means for fixing the lower part in the provisioning position. The fixing means can, for example, comprise clamping means which are adjustable to the lower part of the tray, in particular to the first side walls. Alternatively, the fixing means can engage in recesses on the lower part, for example in the first side walls, to fix the lower part by means of positive locking.

It is advantageous if the second support element is downstream of the first support element in the conveying direction and has a front surface facing the first support element and a rear surface facing away from the first support element, wherein the stop surfaces of the positioning system are arranged flush with and parallel to the rear surface of the second support element.

It is favorable if the tray conveying plane is arranged at a first height level and the load conveying plane at a second height level, wherein the second height level is preferably located above the first height level. This is advantageous in particular if the actuating device is configured according to the aforementioned first or third embodiment.

It is favorable if the first support element and the second support element are arranged at a first distance to one another and are preferably aligned parallel to one another. The upper part of the tray can thereby be received in regions spaced apart from one another, allowing for it to be moved evenly. The first distance between the support elements preferably equates to a distance between the first transport base edge and the second transport base edge. The distance between the transport base edges thereby equates to a transport base width.

It is advantageous if the first support element and the second support element are arranged on either side of the tray, in particular on the two longitudinal sides of the tray.

Particularly preferably, it is provided that the first support element and the second support element are arranged on two parallel longitudinal sides of the tray and are flush with the second side walls of the tray when the tray is in the provisioning position. It is thereby favorable if the upper part, as described above, projects beyond the transport base. The support elements can be configured to receive a region of the upper part which projects beyond the transport base.

It is advantageously provided that the first support element and the second support element are each configured as orthogonally movable lifting elements in relation to the tray conveying plane.

It is thereby favorable if the first support element and the second support element are each driven by a drive device to achieve independent movability of the support elements. The respective drive devices can be controlled accordingly to move the first and second support element synchronously.

The first support element and the second support element are preferably movable between a starting position, located in particular beneath the tray conveying plane, and a lifting position, located in particular above the tray conveying plane. In the lifting position, the upper part can be lifted off the lower part and the loading base moved into the transferring position.

Alternatively, it can be provided that the first support element and the second support element are driven by a shared drive device, whereby a synchronous movement is achieved. Preferably, the first and the second support elements are configured such that they can be moved upwards in relation to the tray conveying device.

It is preferably provided that the lifting elements have a plate-like configuration. Alternatively, the lifting elements can be configured as gripping elements as previously described.

To achieve drive by means of a shared drive device, it can be provided that the first support element and the second support element are mounted on a (shared) lifting frame.

In an alternative embodiment, the first support element and the second support element are movable independently of one another. The second support element, which is downstream of the first support element in the tray conveying direction, can, for example, thus first be moved from the starting position to the positioning position in which the second support element can serve as a stop element for the positioning of the tray in the provisioning position. In a next step, the first support element can first be moved from the starting position to the positioning position and subsequently the first support element and the second support element can be moved synchronously from the positioning position to the lifting position. The positioning system can thus be provided by the actuating device.

To lower the lower part, it is favorable if the third support element is configured as a movable lifting element orthogonally to the tray conveying plane. In particular the aforementioned second and third embodiment of the provision device can thereby be achieved.

It is favorable if the transfer device comprises a pusher mounted movably on a base frame in relation to the tray conveying device. The pusher is thereby movable in a pushing direction which is preferably aligned orthogonally to the tray conveying direction. In the simplest variation, the pusher can perform a translational pushing movement and thereby push the load from the tray, whereby the pushing direction is parallel to the longitudinal axis or to the second side walls of the tray.

It is favorable if the pusher is coupled with a drive device and can be moved from an idle position to an unloading position to push a load or (simultaneously) several loads from the tray onto the transfer location.

Furthermore, it can be advantageous if the drive device has an electronically controlled actuator and is connected to a control device which controls the drive device in such a way that the pusher pushes a predetermined number of loads from the tray onto the transfer location.

According to a further embodiment of the invention, it is possible that the unloading device has a monitoring device, in particular a sensor, to acquire a transfer of a load from the tray to the transfer location, wherein a control device is connected to the monitoring device and controls the transfer device to push a load from the tray onto the transfer location. This measures allows for the transfer of a load from the tray to the transfer location to be monitored or evaluated.

The further object is solved with a method for unloading of the type mentioned at the beginning, wherein the upper part of the tray is received during the relative movement by a first support element and, spaced apart from this, a second support element of the actuating device in opposite edge regions, the lower part of the tray is received during the relative movement by a third support element of the actuating device, and the relative movement is performed in that the first and second support element and the third support element are moved relatively to one another.

The tray is thereby transported to the provisioning location of the unloading device and provided there by means of the tray conveying system in the tray conveying plane. As previously described, the tray is positioned in the provisioning position at the provisioning location by means of the positioning system.

The tray is subsequently moved by the actuating device from the transport configuration into the transferring configuration as described above in connection with the actuating device.

The load is pushed from the tray onto the transfer location by the transfer device when the tray is provided in the transferring configuration. As previously described, this can be performed in particular by means of the pusher.

The load is further transported away from the transfer location by the load conveying system and, for example, transported to an order-picking device or order-picking station where the load is placed on an order loading carrier.

For the transportation away of the (empty or partially unloaded or still partially loaded) tray from the provisioning location, the tray is moved again by the actuating device from the transferring configuration into the transport configuration and subsequently transported away by the tray conveying system.

It is further favorable if the load conveying plane is arranged at a height level spaced apart from the tray conveying plane, wherein a height difference between the load conveying plane and the tray conveying plane is bridged by the relative movement whereby the upper part, when the tray is moved, is raised from the transport configuration into the transferring configuration by the actuating device.

To push the load from the tray onto the transfer location, it is favorable if a loading edge of the loading base is brought to a height level of the load conveying plane when moving the tray.

To raise the upper part relatively to the lower part, it can be provided that the transport base has a first transport base edge and a second transport base edge, wherein the upper part projects with a first contact surface beyond the first transport base edge and with a second contact surface beyond the second transport base edge and for performing the relative movement between the upper part and the lower part the first support element is contacted from below with the first contact surface and the second support element from below with the second contact surface.

The further object is solved with a computer-implemented method as disclosed at the beginning, wherein the method comprises the following steps:
acquiring a loading order for loading a tray with a load by a processing system,
acquiring load dimensions by a load acquisition system and transferring the acquired load dimensions from the load acquisition system to the processing system,
acquiring a loading width of the tray by a tray acquisition system and transfer of the acquired loading width from the tray acquisition system to the processing system,
comparing of the load dimensions with the loading width by the processing system,
determining, by the processing system, a loading pose for the load which is to be placed on the tray, wherein the loading pose is determined using the load dimensions in such a way that a rotation of the load on the tray is limited by the loading width,
generating, by the processing system, a control specification for controlling the position changing device to bring the load into the loading pose,
transferring the control specification from the processing system to the control device and control of the position changing device according to the control specification by the control device.

A particular advantage achieved with the invention is that due to the specific loading pose a reliable, automatic loading of the tray and thus subsequently an automatic unloading of the tray is enabled. In particular, the advantageous loading pose achieves safe transport of the load on the tray such that it cannot rotate. It is thereby ensured that the load can be pushed from the tray in a pushing direction by an automated unloading device. Furthermore, on a tray upon which several loads are arranged in a row, a limitation of the rotation of the load on the tray prevents the loads from moving during transportation of the tray on a conveying device in such a way that they would no longer be positioned in a row but rather next to one another. It is thereby ensured that the loads can be pushed individually or as a load group by the automated unloading device. Furthermore, loads with small dimensions, in particular with a small area, can also be transported without them rotating disproportionately. Moreover, an advantage of the invention is that the advantageous loading pose increases packing density on the tray and thus improves space use in the order-picking system.

The tray can thereby be configured as a one-piece tray which has, for example,
a base with a transport and storage surface on the lower side of the base, first end side, second end side, first longitudinal side, second longitudinal side and loading plane on the upper side of the base, which runs between the first end side and the second end side and is configured to receive the load, and
a first side wall projecting beyond the first loading plane in the region of the first end side, and
a second side wall projecting beyond the second loading plane in the region of the second end side.

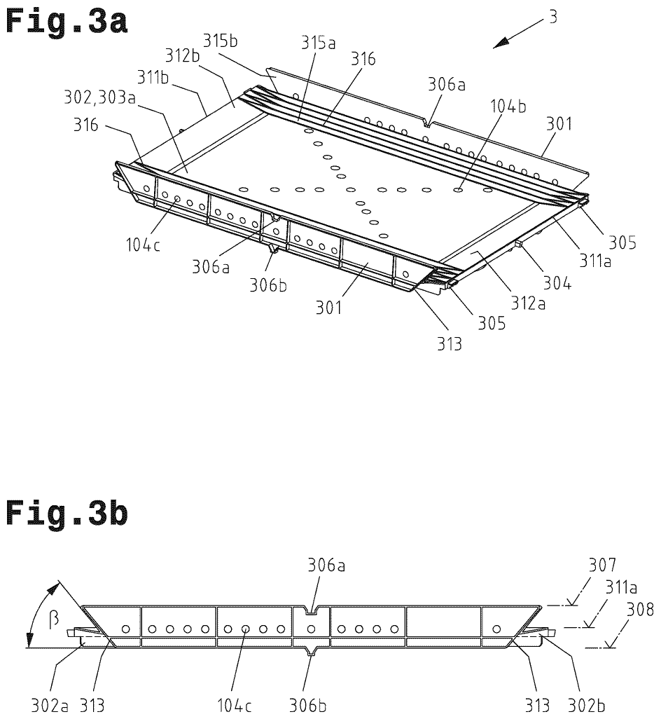

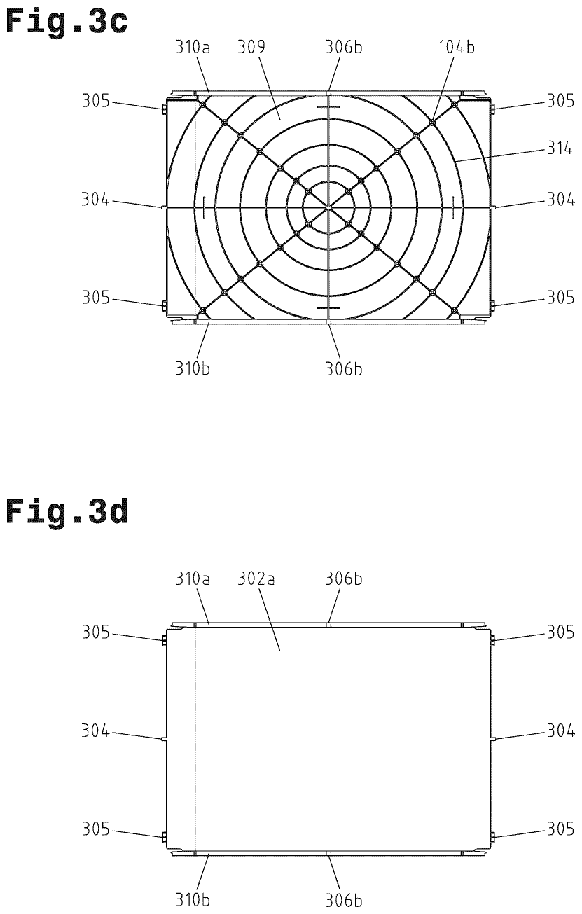

This tray or this load carrier can, in particular, have several loading planes which are each limited in their loading width or receiving width by stop edges. Such a one-piece tray or load carrier is described in detail in WO 2019/140473 A1, in particular with reference to FIGS. 3a to 6d.

Alternatively, the tray can, as described above, be configured as a multi-piece tray with a lower part and an upper part which is movable relative to the lower part.

A tray preferably comprises four side walls and a loading plane. The tray comprises a first end side and a second front where the tray is limited by first side walls, as well as a first longitudinal side and a second longitudinal side where the tray is limited by second side walls.

The loading width defines a width of a receiving compartment of the tray, for example a space between the second side walls of the tray or a distance between the stop edges limiting the receiving compartment. As explained in detail in the following, the acquired loading width can comprise a first loading width and a second loading width and where applicable further loading widths.

As a rule, the load is configured with several side surfaces, in particular each with a diagonal, and several edges each with an edge length. Each of the side surfaces is thereby limited by several of the edges. In the simplest scenario, the load is configured with six side surfaces and twelve edges, wherein the side surfaces are each limited by four of the twelve edges such that the load has a cuboid or cubic configuration.

The computer-implemented method is preferably performed by means of a computer system which comprises the processing system, the load acquisition system and the tray acquisition system.

A (electronically acquired) loading order is thereby acquired by the processing system. The loading order specifies in particular which load is to be loaded onto the tray, how many loads are to be loaded onto the tray, and/or which tray is to be loaded. The processing system can be, for example, a program or program instance performed on the computer system. Alternatively, the processing system itself can be provided by a computer.

The load acquisition system is configured to acquire load dimensions and to transfer load data which contain the load dimensions to the processing system, and can preferably comprise a program or program instance of the processing system as performed on the computer system. Furthermore, the load acquisition system preferably comprises a measuring device for acquiring and/or identifying the load.

According to one embodiment, the load data or load dimensions pertaining to the load saved in an electronic memory can be read or accessed from the electronic memory. For this purpose, the load can, for example, be identified from a load sequence predefined by a material flow computer.

Alternatively, as described in the following, the measuring device can be configured to acquire the load dimensions. For this purpose, the load data which contain the load dimensions can be determined by the load acquisition system by measuring and the actual dimension values transferred to the processing system.

The load dimensions comprise the edge length, the diagonals, and/or an alignment of the side surfaces to one another. The load dimensions thus preferably comprise a length, width, height and/or diagonal of the side surfaces.

Analogously to the load acquisition system, the tray acquisition system is configured to acquire the loading width of the tray and transfer tray data which comprise the loading width to the processing system. The tray acquisition system preferably comprises a program or program instance of the processing system performed on the computer system. It is thereby favorable if the tray data or the loading width are read or accessed from the electronic memory by the tray acquisition system. The identification of the tray using an identification tag, in particular a machine-readable code as described in the following and which is arranged on the tray, is sufficient. The tray data or loading width(s) can be read or accessed from the memory based on the identification. Alternatively or additionally, the tray acquisition system can comprise a measuring device with which the loading width of the tray is determined and transferred to the processing system.

The load dimensions are compared with the loading width by the processing system based on the loading width of the tray and the load dimensions. A diagonal of the side surfaces of the tray are thereby preferably compared with the loading width. Alternatively or additionally, the length, width and/or height of the load can also be compared with the loading width.

The loading pose for the load is determined in a next step. The loading pose specifies in which orientation the load is to be transferred onto the tray and upon which side surface the load should rest on the tray. Preferably, the side surface whose diagonal is greater than the loading width and whose width and/or length is smaller than the loading width is thereby selected. Where that is true of several side surfaces, one of those side surfaces can be selected.

To minimize rotation of the load, the orientation of the load is preferably selected such that the load is aligned orthogonally to the longitudinal axis of the tray with that edge where a difference between an edge length and the loading width is minimized.

Based on the loading pose, the processing system determines a control specification which specifies how the position changing device is to be controlled by the control device to bring the load into the loading pose. The control specification can specify whether the load has to be tilted and/or rotated by the position changing device, by which angle the load has to be tilted and/or rotated by the position changing device, and/or how many times the load has to be tilted and/or rotated by the position changing device to provide the load in the loading pose.

The position changing device is then controlled by the control device according to the control specification such that the load is brought into the loading position by the position changing device.

Furthermore, it is favorable if the load or the load group is aligned relatively to the tray by an alignment device and/or is transferred to the tray by a transfer device.

Moreover, it can be provided that several loads are accumulated by a grouping device, preferably without gaps, to form a load group.

It is favorable if the acquisition of load dimensions comprises an identification of the load and an accessing of the load dimensions from an electronic memory, in particular from a database. Load dimensions pertaining to the load to be identified can thereby be read from the electronic memory, and thus no complex measuring device is required for determining the edge lengths of the load.

As previously mentioned, the load can thereby be identified from a load sequence predetermined by a material flow computer. Alternatively, a measuring device for acquiring a machine-readable code such as a barcode, a QR code or an RFID tag can be provided. For this purpose, the machine-readable code can be arranged on the load. The load acquisition system can be (data-) connected with the measuring device or comprise the measuring device. The load acquisition system can identify the load on the basis of the machine-readable code and access the load dimensions pertaining to the load from the electronic memory.

Alternatively, it can be provided that the load acquisition system comprises a measuring device which is configured to determine the load dimensions, or is (data-) connected with such a measuring device. For this purpose, the measuring device can, for example, comprise a light curtain, one or more light barriers, and/or an image acquisition system and an algorithm for image recognition, as described in detail in the following with reference to the loading device.

It is advantageously provided that the acquisition of the loading width comprises an accessing of the loading width from an electronic memory, in particular from a database. A saved loading width pertaining to the load can also hereby be read from an electronic memory, thus not requiring a complex measuring device for determining the edge lengths of the load. It can thereby in particular be provided that only one type of tray is used in the order-picking system, such that all trays used have the same loading width, meaning that the tray does not need to be identified in advance and rather the loading width simply has to be accessed from the electronic memory.

Furthermore, the tray can be identified from a known and previously generated tray sequence. Alternatively, a measuring device for acquiring a machine-readable code such as a barcode, a QR code or an RFID tag can be provided. For this purpose, the machine-readable code can be arranged on the tray. The load acquisition system can be (data-) connected with the measuring device or comprise the measuring device. The tray acquisition system can identify the tray on the basis of the machine-readable code and access the loading width pertaining to the tray from the electronic memory.

It is preferably provided that the acquisition of the loading order comprises an acquisition of a load quantity which specifies how many loads are to be loaded onto the tray. Depending on their load dimensions, several loads can then be combined into a load group which is loaded jointly onto the tray. By loading a tray with a load group or with several loads, a packing density in a tray storage can be increased and thus space use improved. Furthermore, a number of required trays is reduced. If the load number is greater than one, a number of transport runs to be performed can be reduced because, for example, only one single tray has to be transported if two same loads are needed that are stored on a shared tray. The energy requirement of an order-picking system is thereby reduced.

If several loads are to be loaded onto the tray as a load group, it is advantageous if the loading pose is determined for all loads that are to be loaded onto the tray. The loads can thus first each be individually brought into the loading pose and subsequently already be grouped in the loading pose by the grouping device to form a load group.

Furthermore, it is favorable if the number of loads is considered when determining the loading pose. A loading pose can, where necessary, thereby be selected that would indeed not be permissible for a single load because it could rotate and/or topple over, but which is permissible for the load group because the loads in the load group support and stabilize each other and thus prevent rotation.

It is advantageously provided that when determining the loading pose, the loads to be loaded onto the tray are combined into a load group and dimensions of the load group are calculated according to which the loading pose for each load of the load group is determined based on the dimensions of the load group. It is thereby particularly advantageous if the number of loads is considered in conjunction with the edge lengths of the loads to ensure that a total length of the load group does not exceed a length of the loading plane.

To be able to handle loads with a particularly wide range of load dimensions, it is preferably provided that when acquiring the loading width of the tray a first loading width and a second loading width are acquired, wherein the loading pose is selectively determined for the first loading width and/or the second loading width. The tray can have a first receiving compartment with the first loading width and a second receiving compartment with the second loading width. It can thereby be provided that loads with a lower edge length are placed in the receiving compartment with the first loading width and loads with a greater loading width and placed in the receiving compartment with the wider (larger) loading width and the loading pose determined accordingly. Naturally, this can also be performed for further receiving compartments with further loading widths.

If several loading poses are possible, it is favorable if at least one further loading pose is determined and said loading pose is selected with which a highest packing density on the tray is achieved. This can be the case, for example, if a first loading pose can be determined for the first loading width and a second loading pose for the second loading width.

Using the advantages and effects described above, the further object is solved further with a (automated) loading device of the type mentioned at the beginning, wherein the loading device has a load acquisition system for acquiring load dimensions, a tray acquisition system for acquiring the loading width of the tray, and a processing system, and wherein the load acquisition system, the tray acquisition system, the processing system, the control device and the position changing device are configured to perform the steps of the aforementioned computer-implemented method.

A particular advantage achieved with the loading device is that the trays can be automatically and reliably loaded with loads such that the loads are secured (against rotation) during transportation on the tray. It is favorable if the loading device comprises a tray. Further, it is advantageous if the tray is configured according to one of the previously described aspects.

The load and the tray can be transported to the transfer system and provided there by means of the load conveying system and the tray conveying system. The transfer system is preferably downstream in the conveying direction from the load conveying system.

In a preferred embodiment, the load conveying system comprises a load conveying device for transporting the load to the transfer system in a conveying direction, wherein the load conveying device defines a load conveying plane. Furthermore, the tray conveying system comprises a tray conveying device for transporting the tray in the conveying direction, wherein the tray conveying device defines a tray conveying plane. During the transportation of the tray, the tray is aligned with the longitudinal axis preferably parallel to the conveying direction. The tray conveying plane is arranged at a first height level and the load conveying plane at a second height level, wherein the second height level is below the first height level such that the load can be placed onto the tray from above. The loading of the tray can occur continuously and thus without the tray being stopped during a loading process.

Furthermore, it is favorable if the transfer system comprises a transfer conveying device running between a transfer edge and a transfer edge which takes over the load at the transfer edge of the load conveying device and dispenses it onto the tray at the transfer edge. To bridge a height gap between the first height level and the second height level, the transfer conveying device has an inclined transfer conveying plane. The tray is provided by the tray conveying device beneath the transfer edge of the transfer conveying device, in particular with continuous movement in the conveying direction. The load can be dispensed onto the tray during the continuous movement of the load and the tray in the conveying direction.

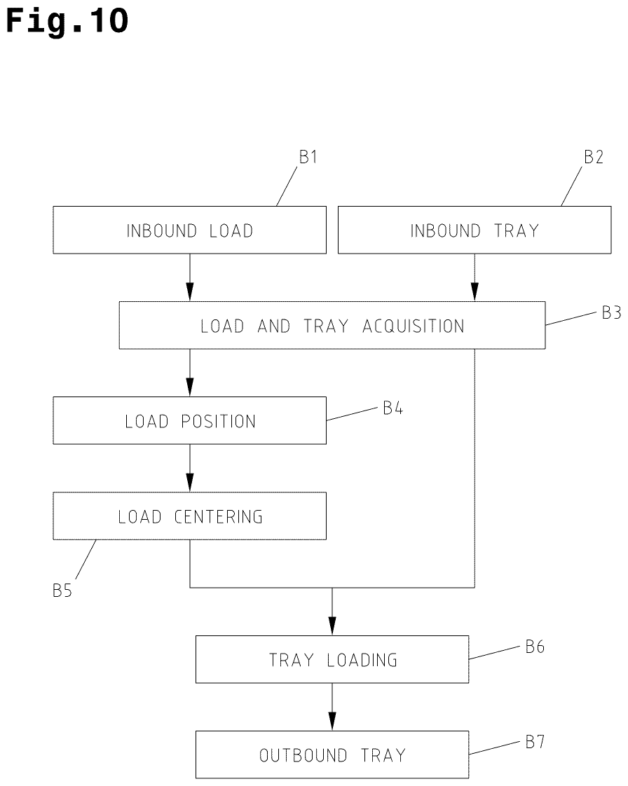

Alternatively, the transfer system can be constructed in the same way as the previously described unloading device and comprise a pusher with which the load or the several loads can be pushed from the load conveying device onto a provided tray. Such a transfer system is described, for example, in WO 2019/140473 A1, FIG. 10.

The load conveying device and/or tray conveying device and/or transfer conveying device can, in particular and as previously described, be configured as a stationary conveying device or as a mobile conveying device.

It is favorable if the transfer conveying device is configured as a knife edge conveyor.

Using the advantages and effects described above, it is favorable if the tray comprises a second receiving compartment which forms a second loading plane at a second height level and is designed with a loading width (second loading width) which is wider than the loading width of the receiving compartment (first loading width).

Furthermore, it can be provided that the position changing device comprises an alignment device for positioning the load on the load conveying system. The load can thereby be centered relative to the tray or relative to the receiving compartment of the tray and be positioned accordingly on the load conveying device. If several loads are to be transferred onto the tray, it can thereby be ensured that the loads are transferred onto the tray centrally and in a row along the longitudinal axis of the tray.

To bring the load into the loading pose, it is advantageous if the position changing device comprises a rotation device and/or tilting device for changing a pose of the load. A side surface of the load with which the load rests on the load conveying device and thus also on the tray can be changed using the tilting device. Furthermore, the load can be rotated around a, in particular vertical, rotational axis by the rotation device, allowing an orientation of the load to be changeable.

It is particularly preferable for the loading device to comprise, in the conveying direction, a first rotation device, a first tilting device, and a second rotation device in sequence. The load can thereby be tilted onto in particular five side surfaces. Optionally, the position changing device can have a second tilting device which is arranged in particular in the conveying direction before the first rotation device. The load can thereby be tilted onto six or more side surfaces.

It is favorable if the tilting device comprises a first tilting arm and a second tilting arm which form a right angle and which are rotatable around a horizontal axis of rotation. To tilt the load, it can be received between the first tilting arm and the second tilting arm and be tilted around an axis of rotation by rotation of the tilting arms, in particular from a first pose in which the load is resting on a first side surface to a second pose in which the load is resting on a second side surface. The tilting arms can have a comb-like configuration and extend across a width of the conveying plane, wherein comb teeth are each arranged between two conveying elements of the load conveying device, in particular conveyor rollers, and can be passed through them.

Furthermore, it is advantageous if the rotation device comprises a plurality of driven conveying elements, in particular conveyor wheels, and a lifting and rotating platform. The lifting and rotating platform is movable orthogonally to the load conveying plane between a starting position beneath the load conveying plane and a lifting position above the load conveying plane and is rotatable around an axis of rotation which is orthogonal to the load conveying plane. Furthermore, the lifting and rotating platform comprises a plurality of openings through which the conveying elements project if the lifting and rotating platform is positioned in the starting position. The lifting and rotation platform is preferably configured rotationally symmetrically around the axis of rotation.

In order to rotate the load, it is lifted from the load conveying plane by a movement of the lifting and rotating platform from the starting position into the lifting position and rotated about the axis of rotation by rotating the lifting and rotating platform, in particular by 90°, 180° or 270°. If the load is in the desired alignment, the load is dispensed back to the conveyor elements by lowering the lifting and rotating platform from the lifting position into the starting position and is further transported further by the conveyor elements.

It is further expedient for the position changing device to have a buffer device provided by the load conveying device between the rotation device and the alignment device and/or a buffer device provided by the load conveying device between the alignment device and the transfer system.

The load acquisition system advantageously comprises a measuring device with a sensor which is arranged along the conveying system for transporting the load and is configured to acquire the load dimensions. As a result, the load can be acquired during transport, identified by reading an identification mark, and/or measured by contactless measurement.

The sensor system can have a camera system to acquire the load by measurement. In this case, the dimensions of the load can be determined by an algorithm for image recognition, for example Alternatively, the sensor system can have one or more light barriers or a light curtain or a light grid for acquiring the dimensions of the load.

The sensor system can alternatively or additionally comprise a reader for identifying the load by reading a machine-readable code arranged on the load. The machine-readable code can be a barcode, a QR code or an RFID tag, for example. In this case, the load dimensions based on the identification can be read from an electronic memory, in particular from a database.

In order to dispense a plurality of loads substantially simultaneously, it can be provided that the load conveying system comprises a grouping device for creating a load group from several loads. The grouping device can be formed, in particular, by storage spaces on the load conveying device, which make it possible for a plurality of loads to be stored leaving no gaps. The loading group can then be dispensed to the shelf by means of the transfer system.

For this purpose, the grouping device can comprise a drive device and a stop element that can be moved by the drive device between a starting position and a grouping position, essentially analogous to the positioning device described above. In the starting position, the stop element is (completely) below the load conveying plane, and the stop element projects beyond the load conveying plane in the grouping position. In this case, the stop element can comprise a plurality of stop elements that can be moved independently of one another, in particular a first stop element, a second stop element, and a third stop element. The drive device can have a drive for each stop element.

A further problem of the invention is solved using the aforementioned advantages and effects by the type of order-picking system mentioned at the outset, wherein the trays and/or the unloading device and/or the loading device are designed according to one of the aforementioned aspects.

Such an order-picking system enables automatic loading and/or automatic unloading of the tray.

The order-picking system can further comprise an incoming storage, a tray storage for loads stored on trays and an order-picking device for automatically or manually picking loads on order loading carriers.

The incoming storage can be configured as a manual storage, semi-automated storage or fully automated storage. In the incoming storage, the loads are delivered on storage structures, for example pallets, containers and the like, and stored on storage racks. The loads are stacked on a storage structure, in particular in an article-by-article manner. In a preferred embodiment, the incoming storage is configured as an automated pallet storage. Such a pallet storage comprises storage racks and storage and retrieval devices, each of which can be moved automatically in a rack aisle between storage racks, for storing storage structures in the storage racks and retrieving storage structures from the storage racks. The storage racks comprise a plurality of storage stations next to one another in rack levels above one another on which the storage structures can be placed. The storage and retrieval devices are equipped with a load receiving device, which can store one or more storage structures on both sides in a transverse direction in the storage racks and retrieve them from the storage racks.

The tray storage is designed for storing loads and is also configured as an automated storage in a preferred embodiment. The loads are stored on trays in this case. Such a tray storage comprises storage racks and storage and retrieval devices, each of which can be moved automatically in a rack aisle between storage racks, for storing trays in the storage racks and retrieving trays from the storage racks. The storage racks comprise a plurality of storage stations next to one another in rack levels above one another on which the trays can be placed. Preferably, storage and retrieval devices that can be controlled independently of one another for storing trays in the storage racks and retrieving trays from the storage racks are arranged per rack aisle in travel planes above one another. At least one storage and retrieval device can be assigned to each rack level, for example. Thus, one storage and retrieval device serves one rack level. Such storage and retrieval devices are referred to as single-level storage and retrieval devices (shuttles). It is also possible to use fewer storage and retrieval units than rack levels. A storage and retrieval device is moved between the travel planes using a lifting device, for example. An embodiment is also possible in which a single storage and retrieval device is provided for each rack aisle for storing trays in the storage racks and retrieving trays from the storage racks. Said rack storage and retrieval devices are movable in a longitudinal direction (direction x) along the storage racks and equipped with a load receiving device, which can store one or more trays on both sides in a transverse direction (direction z) in the storage racks and access these from the storage racks. WO 2013/090970 A2 and WO 2020/113249 A1 disclose an automatically operated storage with single-level storage and retrieval units (shuttles), which can be used as shelf storage for the storing loads.

The order-picking device can be configured for manual or automated loading of order loading carriers. The order load carrier is, for example, a roll container or a pallet on which the loads are stacked according to an order, in particular according to a picking order. An order-picking device for manually loading order loading carriers is described in WO 2009/109218 A1, for example. An order-picking device for manually loading order loading carriers is described in U.S. Pat. No. 8,708,637 B2, for example.

The figures below elaborate on the invention to offer better understanding thereof.

The figures each show in greatly simplified, schematic depiction:

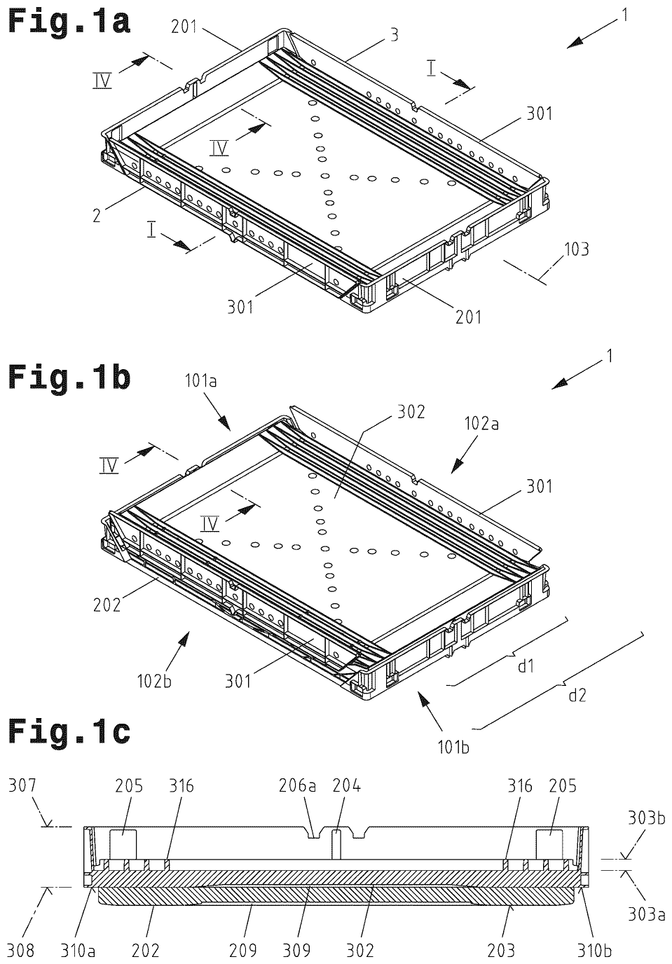

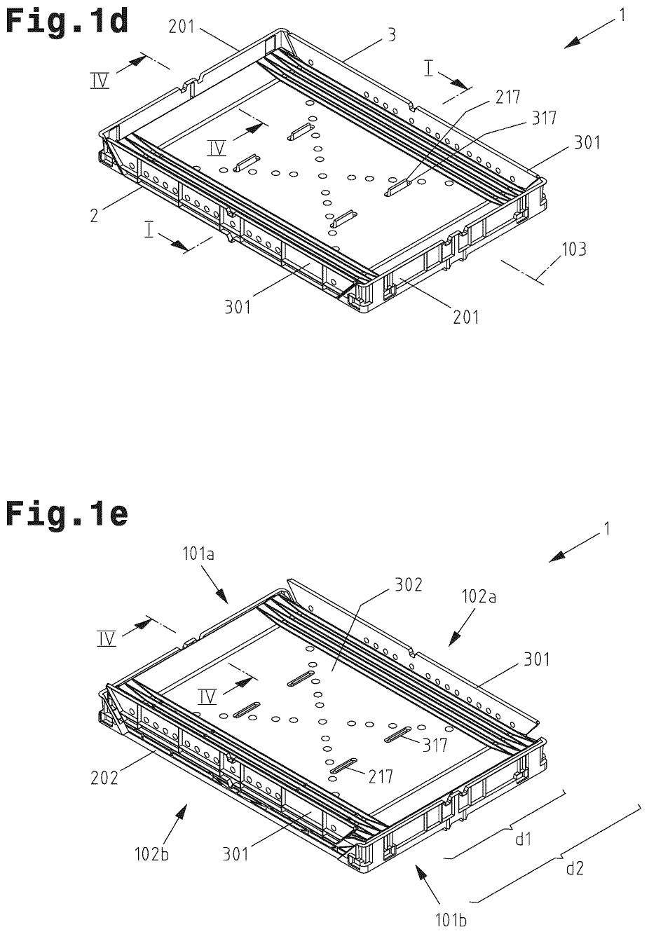

FIGS. 1a and 1d a perspective view of a tray in a transport configuration,

FIGS. 1b and 1e a perspective view of the tray in a transferring configuration,

FIG. 1c the tray in the transport configuration, cut according to the line I-I,

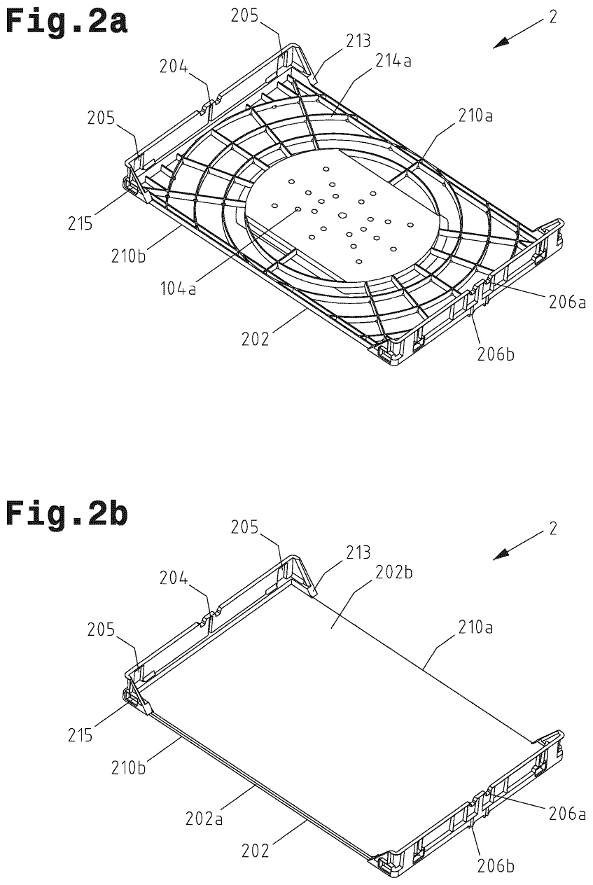

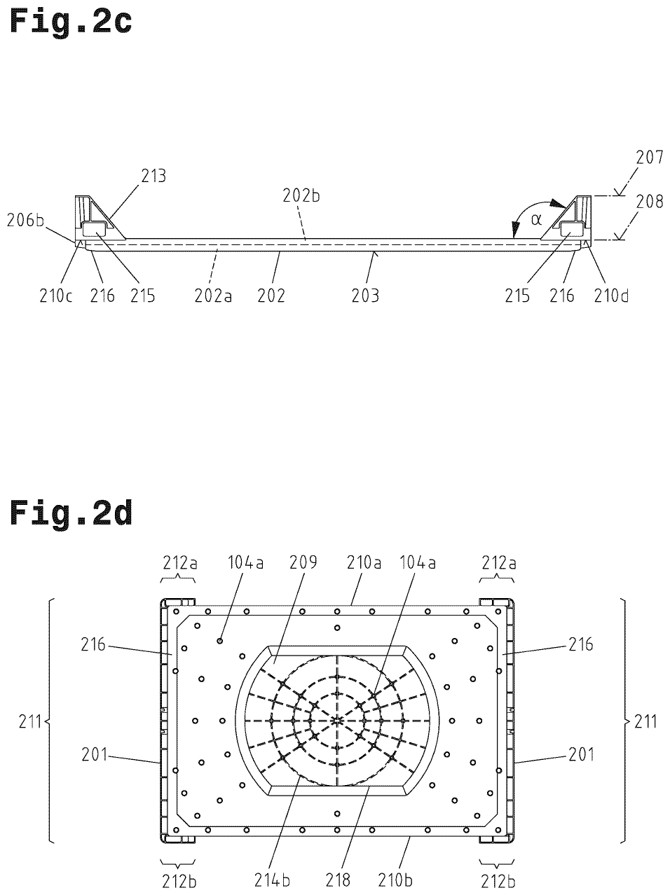

FIGS. 2a and 2b a perspective view of a lower part of the tray,

FIG. 2c a side view of the lower part of the tray,

FIG. 2d a view from below of the lower part of the tray,

FIG. 3a a perspective view of an upper part of the tray,

FIG. 3b a side view of the upper part of the tray,

FIGS. 3c and 3d a view from below of the upper part of the tray,

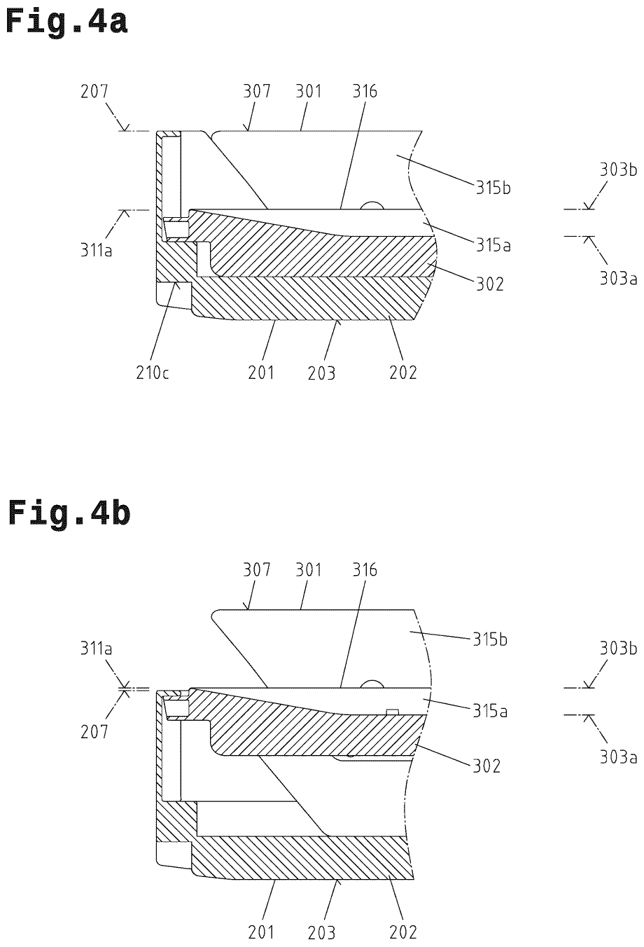

FIG. 4a the tray in the transport configuration, cut according to the line IV-IV in FIG. 1a,

FIG. 4b the tray in the transport configuration, cut according to the line IV-IV in FIG. 1b,

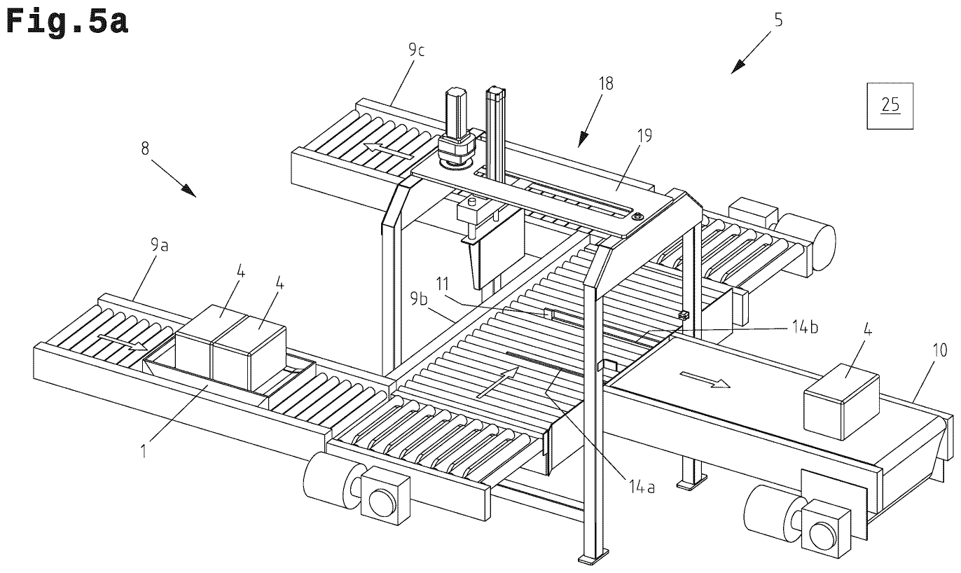

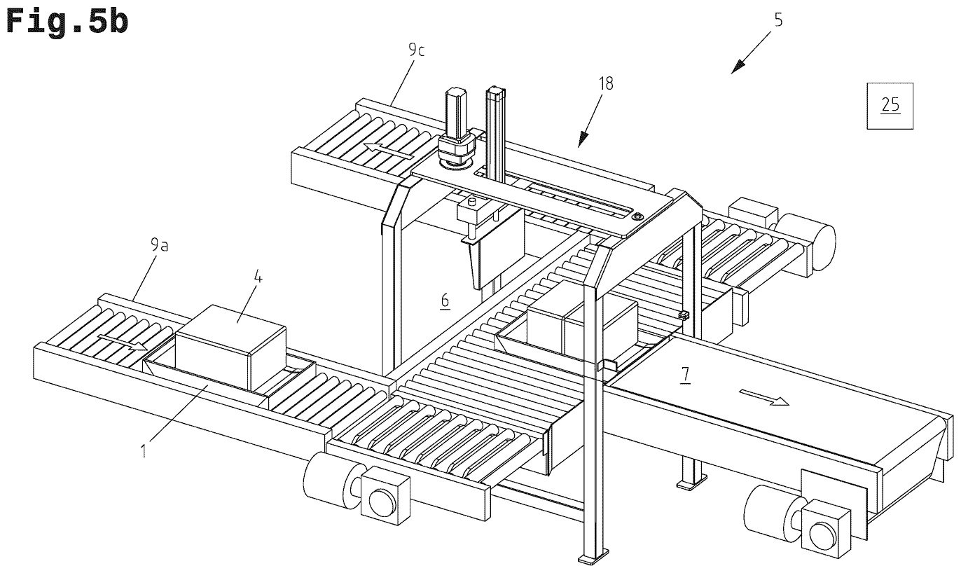

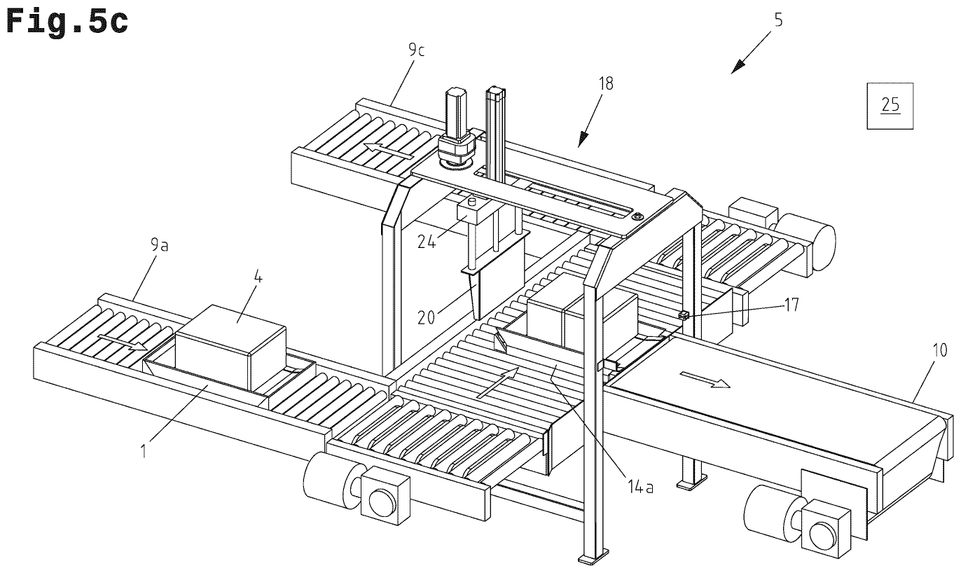

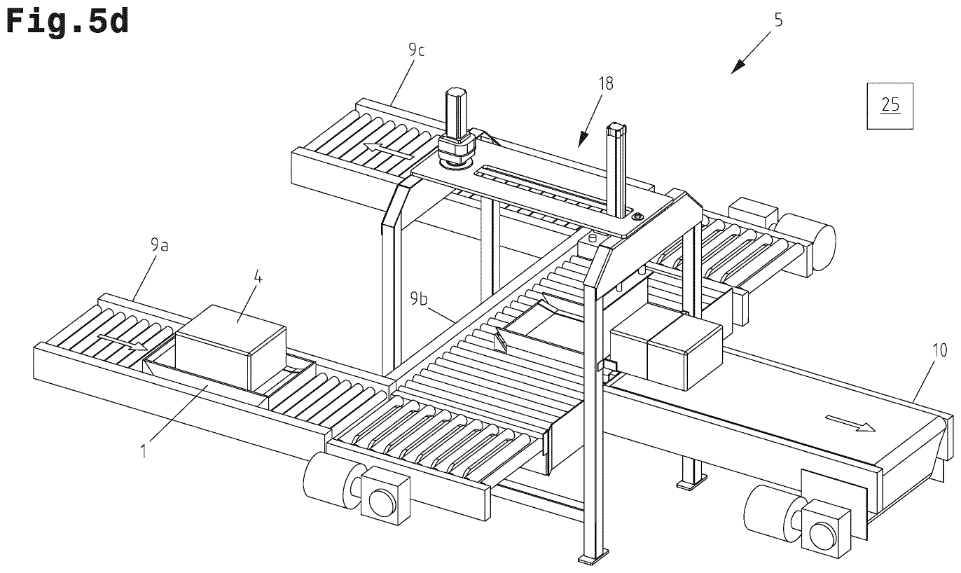

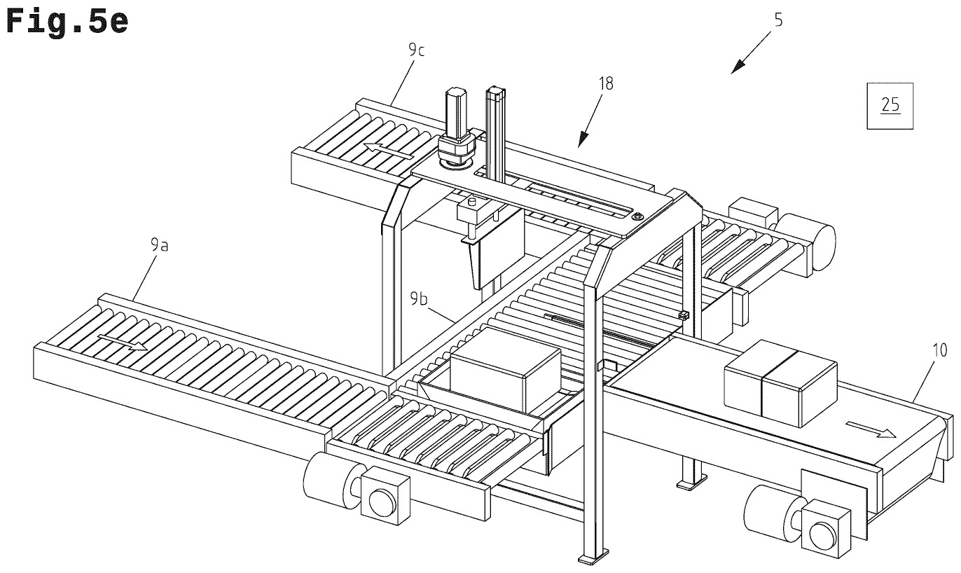

FIGS. 5a to 5e an unloading device for (automatically) unloading a tray loaded with one or more loads, wherein, for example, in FIG. 5b, a tray is provided in the transport configuration on a provisioning location and, for example, in FIG. 5c, the tray shown in FIG. 5a is provided in the transferring configuration on the provisioning location,

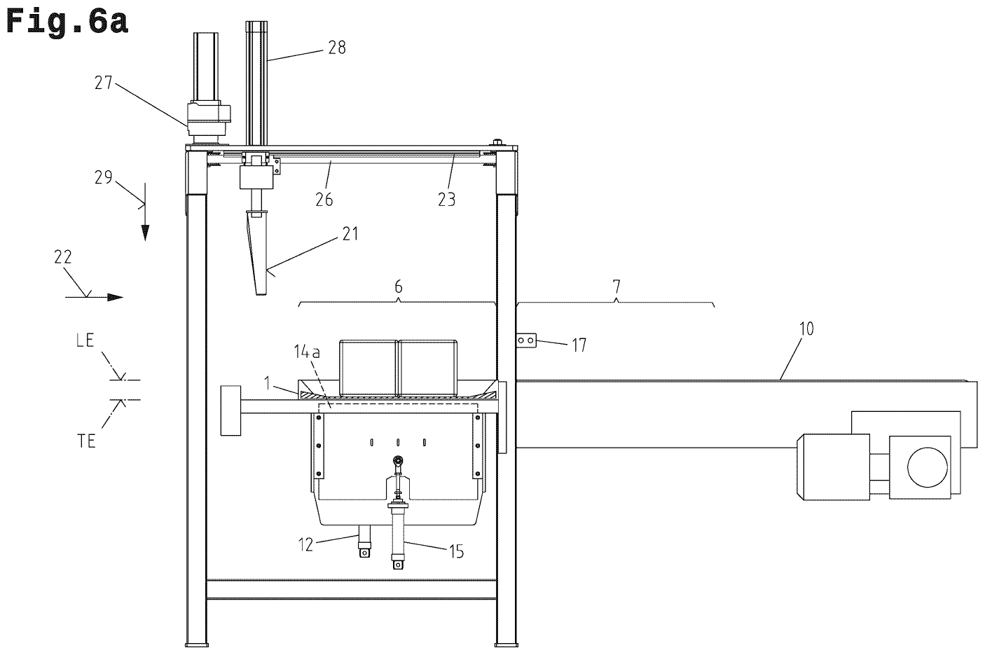

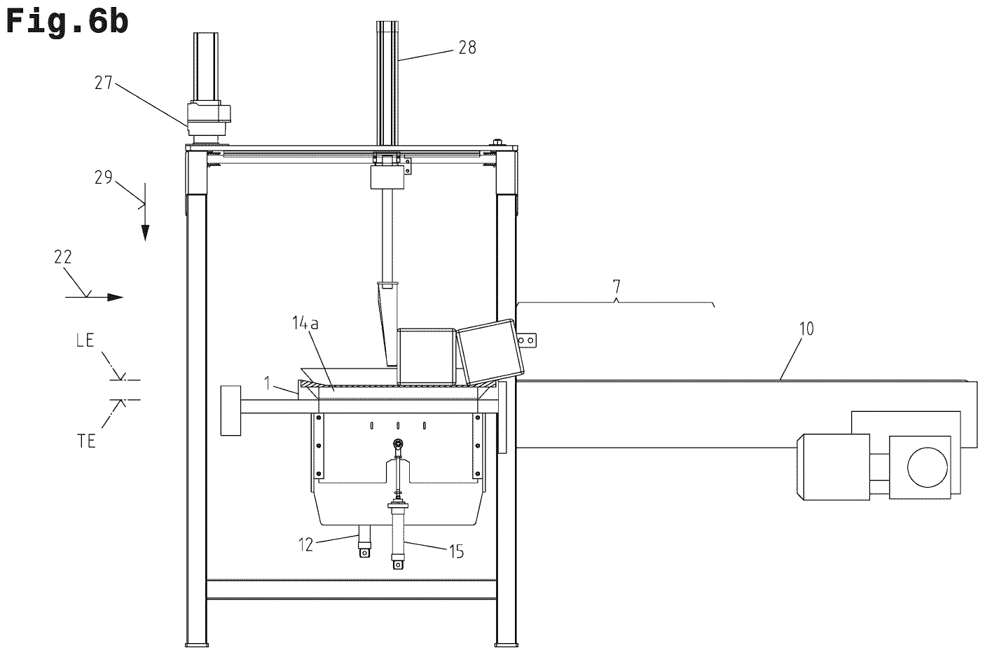

FIGS. 6a and 6b a cross-sectional view of the unloading device, wherein in FIG. 6a, a tray is provided in the transport configuration on the provisioning location and in FIG. 6b, the tray shown in FIG. 6a is provided in the transferring configuration on the provisioning location,

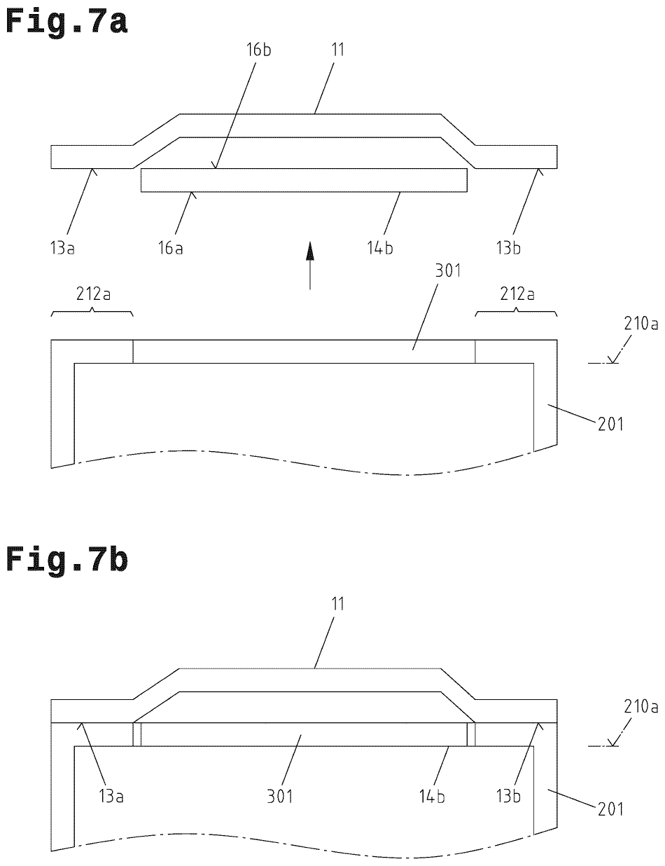

FIGS. 7a and 7b a positioning system of the unloading device,

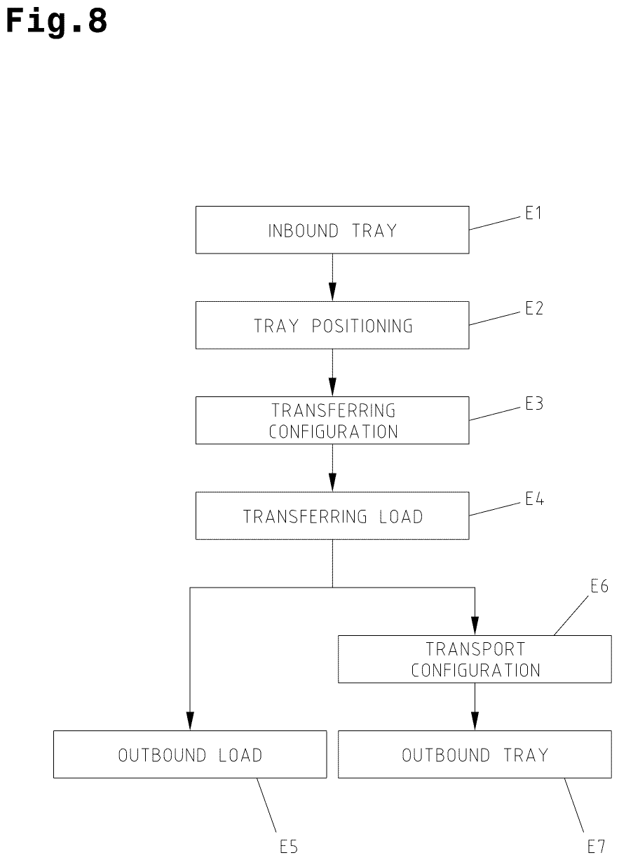

FIG. 8 a method for (automatically) unloading a tray loaded with one or more loads,

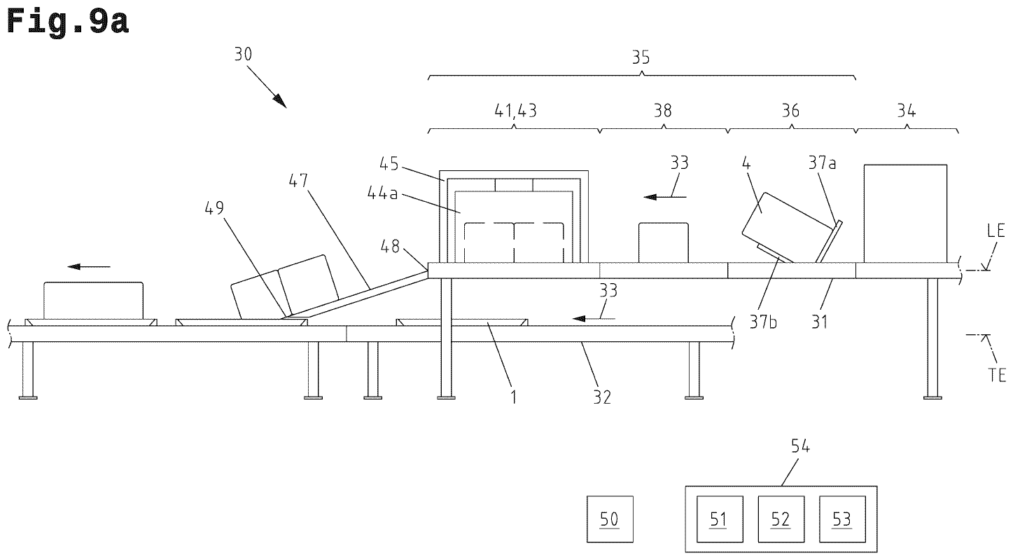

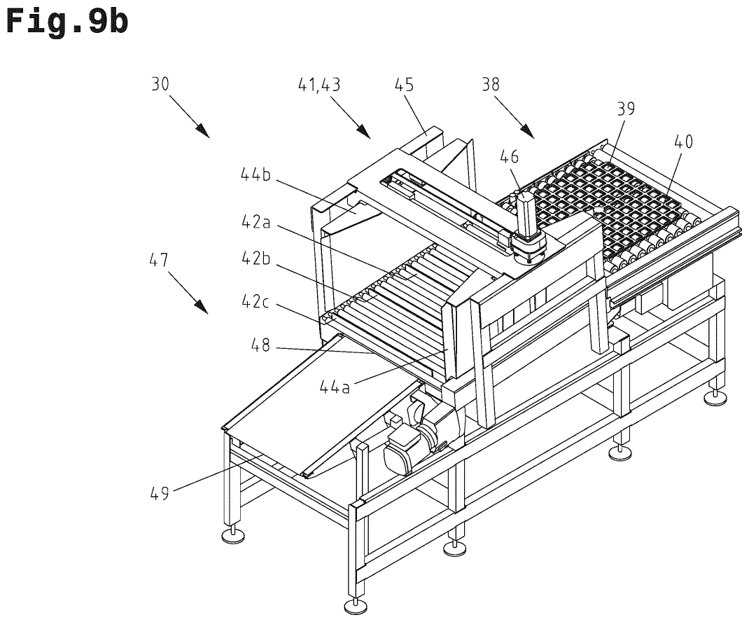

FIG. 9a a side view of a loading device for (automatically) loading a tray with a load,

FIG. 9b a perspective view of a partial section of the loading device,

FIG. 10 a schematic view of a method for (automatically) loading a tray loaded with one or more loads,

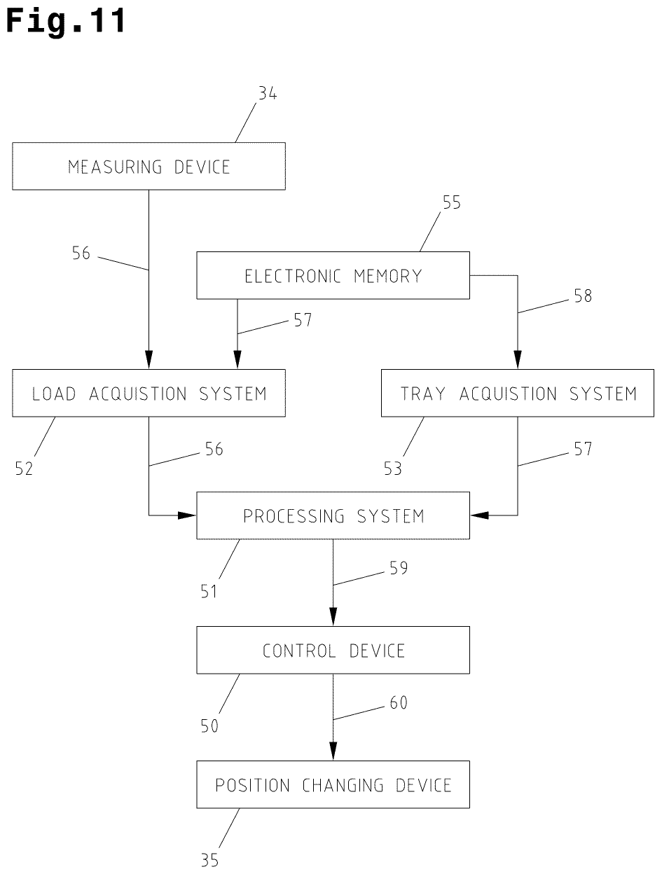

FIG. 11 a computer-implemented method for controlling a position change device,

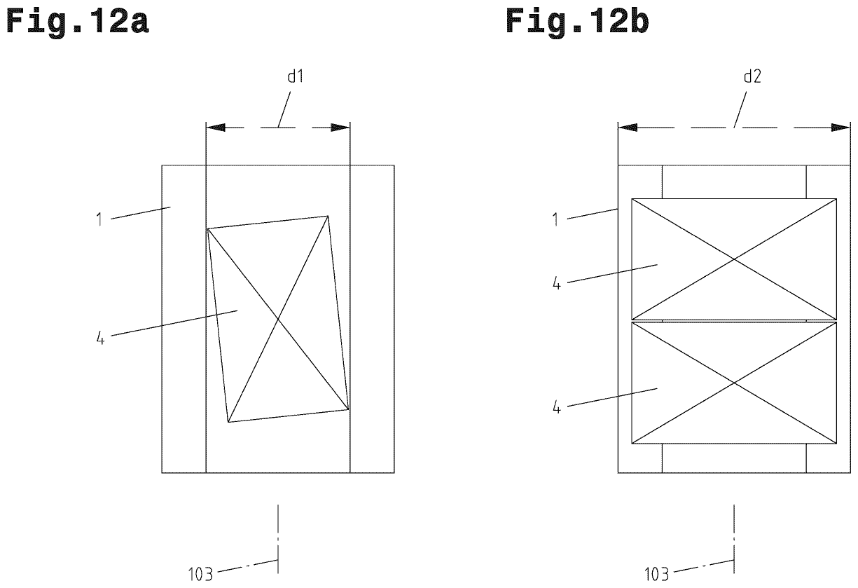

FIG. 12a a plan view of a tray with a load,

FIG. 12b a plan view of a tray with two loads,

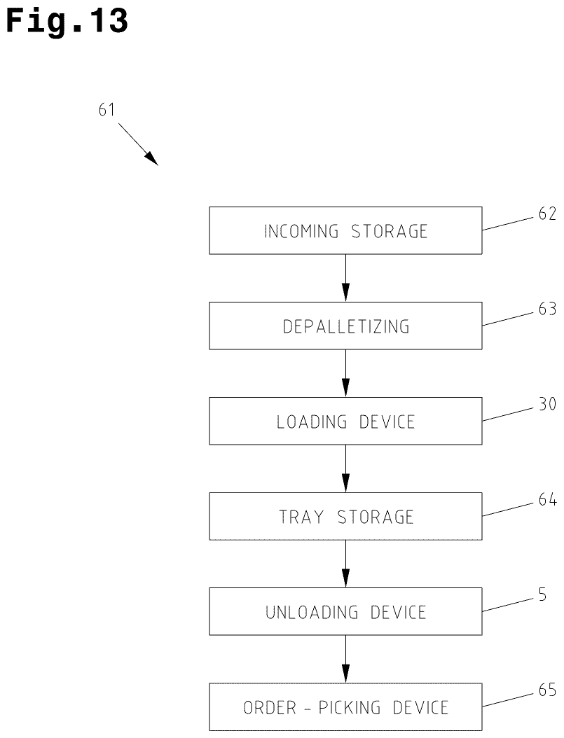

FIG. 13 a schematic view of an order-picking system for storing and picking loads.

It is worth noting here that the same parts have been given the same reference numerals or same component designations in the embodiments described differently, yet the disclosures contained throughout the entire description can be applied analogously to the same parts with the same reference numerals or the same component designations. The indications of position selected in the description, such as above, below, on the side etc. also refer to the figure directly described and shown, and these indications of position can be applied in the same way to the new position should the position change.

In FIG. 1a to FIG. 1e, FIG. 2a to FIG. 2d, FIG. 3a to FIG. 3d, FIG. 4a and FIG. 4b, an embodiment of a tray 1 for transporting a load 4 is illustrated, which is described below with reference to these illustrations.

In FIG. 1a and FIG. 1b as well as in FIG. 1d and FIG. 1e, the tray 1 is shown in a perspective view. FIG. 1c corresponds to a cross section along the line I-I drawn in FIG. 1.

The tray 1 comprises a first end side 101a and a second end side 101b opposite the first end side 101a, as well as a first longitudinal side 102a and a second longitudinal side 102b opposite the first longitudinal side 102a, wherein the longitudinal sides 102a, 102b extend between the end sides 101a, 101b and each form a right angle therewith. A longitudinal axis 103 of the tray 1 extends in parallel to the longitudinal sides 102a, 102b.

Furthermore, the tray 1 is constructed in multi-part fashion and comprises a lower part 2 and an upper part 3 that can be moved relative to the lower part 2. The tray 1 can be moved from a transport configuration shown in FIG. 1a to a transferring configuration shown in FIG. 1b and vice versa by means of a relative movement between the upper part 3 and the lower part 2.

Furthermore, the tray 1 comprises four side walls 201, 301, which are arranged along the end sides 101a, 101b and along the longitudinal sides 102a, 102b. As is visible in FIG. 1a, the four side walls 201, 301 form a circumferential boundary for an interior of the tray 1 when the tray is in the transport configuration. The load 4 can be positioned between the four side walls 201, 301 on the upper part 3 in the transport configuration.

FIG. 1b shows that first side walls 201 arranged along the end sides 101a, 101b and second side walls 301 arranged along the longitudinal sides 102a, 102b of the four side walls 201, 301 are arranged offset from one another, in particular in a height direction, when the tray is in the transferring configuration. Thus, the interior of the tray 1 is open at the end sides 101a, 101b and the load 4 can be pushed away from the upper part 3 as will be explained in detail below.

The lower part 2 comprises a transport base 202, which comprises an upper side facing the upper part 3 a lower side facing away from the upper part 3. The transport base 202 forms a transport surface 203 on the lower side, which is suitable for being transported on an automated conveying device and placed on storage spaces in storage racks. Furthermore, the lower part 2 comprises two of the four side walls 201, 301, which form the first side walls 201 and project upwards from the transport base 202. The transport base 202 can, as illustrated in FIG. 2b and FIG. 2c, in particular comprise a lower base 202a and an upper base 202b with an intermediate space arranged therebetween.

The upper part 3 comprises a transport base 302, which has a lower side facing the lower part 2 and an upper side facing away from the lower part 2. The loading base 302 forms a first loading plane 303a at the upper side, which is suitable for receiving a load 4 or a plurality of loads 4. In addition, the upper part 3 comprises two of the four side walls, which form the second side walls 301 and project upwards from the loading base 302. Similarly to the transport base 202, the loading base 302 can also comprise a lower base 302a and an upper base 302b with an intermediate space arranged therebetween.

In addition, the tray 1 can have a plurality of optional drainage openings 104a . . . 104c, which enable improved drainage of liquid from the tray 1. The drainage openings 104a . . . 104c comprise lower drainage openings 104a arranged in the transport base 202, upper drainage openings 104b arranged in the loading base 302 and/or lateral drainage openings 104c arranged in the first side walls 201 and/or in the second side walls 301.

The lower part 2 can comprise first guide elements 204 in order to guide the upper part 3 during the relative movement between the upper part 3 and the lower part 2. Accordingly, the upper part 3 can have second guide elements 304, the first and second guide elements 204, 304 being configured to engage in a complimentary manner into one another.

In the example shown, the first guide elements 204 are each configured as a guide groove in the first side walls 201. The second guide elements 304 are correspondingly each configured as a guide projection.

As in the example shown, loss protection can be realized analogously to the guidance of the upper part 3. In this case, it is provided that the lower part 2 has first securing elements 205 and the upper part 3 has second securing elements 305, the first and second securing elements 305 being configured to engage in a complementary manner into one another. In the example shown, the first securing elements 205 are each configured as a securing groove in the first side walls 201. The second securing elements 305 are correspondingly each configured as a securing projection. Optionally, in addition to or as an alternative to the guide elements 204, 304, the securing elements 205, 305 can serve to guide the upper part 3 during the relative movement if no guide elements 204, 304 are present, for example.

The first securing elements 204/or the first securing elements 205 can each provide an upper stop for the respective corresponding second guide elements 304 and/or second securing elements 305 in order to limit the relative movement such that the upper part 3 is not fully lifted out of the lower part 2.

In order to achieve mutual positional fixing of trays 1 stacked above one another, it can be provided that the lower part 2 has a plurality of first stacking elements 206a and second stacking elements 206b corresponding thereto. The first stacking elements 206a can be configured as a stacking recess in an upper edge 207 of the first side walls 201. Correspondingly, the second stacking elements 206b can be molded as a stacking lug on a lower edge 208 of the first side walls 201. Additionally, as shown in the indicated example, it can be provided that the upper part 3 also has first stacking elements 306a and second stacking elements 306b corresponding thereto. The first stacking elements 306a can be configured as a stacking recess in an upper edge 307 of the second side walls 301 and the second stacking elements 306b molded to a lower edge 308 of the second side walls 301 as a stacking lug. For this purpose, the stacking lugs and stacking depressions of the upper part 3 and/or of the lower part 2 are configured such that the stacking lugs of a first tray 1 can be received by the stacking depressions of an identically configured second tray 1 when the first tray 1 is stacked on the second tray 1.

As can be seen in FIG. 1c, the transport base 202 can have a recessed recess 209 on the lower side of the transport base 203, thereby achieving increased smoothness of the tray 1.

In the example shown, the loading base 302 rests at least in sections on the transport base 202 when the tray 1 is in the transport configuration as shown in FIG. 1c. Particularly the lower base 302a of the loading base 302 can rest on the upper base 202b of the transport base 202 if the transport base 202 and the loading base 302 are accordingly configured. As can be seen from FIG. 1b, the loading base 302 is positioned spaced from the transport base 202 when the tray 1 is in the transferring position. The loading base 302 can optionally have a recessed recess 309 on the lower side.

As further shown in FIG. 1c, the transport base 202 extends in a width direction orthogonal to the longitudinal axis 103 between a first transport base edge 210a and a second transport base edge 210b. The upper part 3 or the loading base 302 projects with a first contact surface 310a beyond the first transport base edge 210a and with a second contact surface 310b beyond the second transport base edge 210b.

Furthermore, as illustrated by way of example in FIG. 1d and FIG. 1e, the tray 1 can be subdivided in the longitudinal direction into a plurality of storage positions. A plurality of projections 217 can be arranged on the transport base 202, in particular on the upper base 202b of the transport base 202, for this purpose. For receiving the projections, the loading base 302, in particular the lower base 302a and the upper base 302b of the loading base 302, can have a plurality of openings 317 extending therethrough, into which the projections 217 engage. In the transport configuration shown in FIG. 1d, the protrusions 217 protrude beyond the first loading plane 303a to separate the storage positions from one another. In order to enable pushing off, it is provided that, as shown in FIG. 1e, the projections 217 do not protrude beyond the first loading plane 303a in the transferring configuration, for example terminate flush therewith or are arranged in a recessed manner therefrom. For the sake of clarity, the protrusions 217 and openings 317 are not shown in FIG. 1c and subsequently in FIG. 2a to FIG. 4b, although such protrusions 217 and openings 317 can optionally be provided.

The lower part 2 of the tray 1 is shown in FIG. 2a to FIG. 2d, wherein the lower part 2 is shown in perspective view in FIG. 2a and in 2b, in a side view orthogonal to the longitudinal axis 103 of the tray 1 in FIG. 2c and in a lower view of the lower side of the transport base 202 in FIG. 2d.

The transport base 202 provides a base. The first side walls 201 each form a flange mounted on the base such that the lower part 2 is substantially configured in a U shape.

As can be seen in FIG. 2a and FIG. 2b, the first guide elements 204 and/or the first securing elements 205 can be formed in the first side walls 201 and aligned orthogonally to the transport base 202, such that the upper part 3 can be moved substantially along an motion axis (not shown) aligned orthogonally to the transport base 202 during the relative movement.

The first side walls 201 can each comprise an end portion 211, which extends along the respective end side 101a, 101b, in particular across an entire breadth of the tray 1. In addition, the first side walls 201 can each have a first longitudinal portion 212a, which orthogonally adjoins a first end of the end portion 211 and extends along a first longitudinal side 102a of the tray 1. In addition, the first side walls 201 can each have a second longitudinal portion 212b, which orthogonally adjoins a second end opposite the first end of the end portion and extends along the second longitudinal side 102a. Thus, the first side walls 201 each form two corners or corner portions of the tray 1.

At one end of the longitudinal sections 212a, 212b, the first longitudinal section 212a and the second longitudinal section 212b are each provided with a first inclined surface 213, which extends between the lower edge 208 and the upper edge 207 of the respective first side wall 201. As can be seen in particular in FIG. 2c, the first inclined surface 213 forms an (obtuse) angle α with an imagined plane parallel to the transport base 202, said angle is approximately 130° in the example shown. Of course, the angle α can be selected as desired, in particular from 90° to 180°. The inclined surface 213 can also be configured as a vertical surface if the angle α is 90°, for example.

The transport base 202, in particular the lower base 202a of the transport base 202, has an inner surface on the upper side, wherein a plurality of upper stiffening ribs 214a are provided on the inner surface. The upper stiffening ribs 214a are distributed over the inner surface and project from the inner surface, in particular upwards or in the direction of the upper part 3. If the transport base 202 comprises a lower base 202a and an upper base 202b arranged parallel thereto as shown in FIG. 2b, provision is preferably made for a plurality of upper stiffening ribs 214a to be arranged between the lower base 202a and the upper base 202b. In this case, the upper stiffening ribs 214a are covered by the upper base 202b.

Furthermore, the transport base 202 has an outer surface on the lower side, wherein a plurality of lower stiffening ribs 214b can be provided on the outer surface. The lower stiffening ribs 214b are distributed over the outer surface and project from the outer surface, in particular downwards or away from the upper part 3. As can be seen in FIG. 2d, the lower stiffening ribs 214b can be arranged in the aforementioned recess 209 in the transport base 202 as per the example shown. The transport base 202 can further comprise a cover 218 with which the lower stiffening ribs 214b shown in dashed lines are covered.

Although an arrangement of the upper and lower stiffening ribs 214b may be chosen arbitrarily, the upper stiffening ribs 214a in the example shown are arranged such that they form a plurality of intersection points at which they intersect. The lower stiffening ribs 214 in the example shown are also arranged such that they form a plurality of intersection points at which they intersect. Preferably, some of the upper and lower stiffening ribs 214a, 214b are substantially concentric about a central point, and some of the upper and lower stiffening ribs 214a, 214b are arranged radially from the central point.

A plurality of engagement openings 215 for gripping means can be provided in the first side walls 201, in particular in the longitudinal portion 212a, 212b and/or in the end portion 211. These enable positive engagement of a gripping means of a tray handling device, such as a stacking machine, in order to handle trays and stack a plurality of trays one on top of the other, if necessary.

As can be seen in FIG. 2c and FIG. 2d, the transport base 202 can have a circumferential transport bevel 216, in particular inclined from the transport surface 203 to a circumferential transport base edge in the direction of the upper side.

Furthermore, the transport base can have a third transport base edge aligned parallel to the first side walls and a fourth transport base edge aligned parallel to the first side walls. In this case, the third and fourth transport base edges adjoin the transport bevel 216. As shown in FIG. 2c, the lower part projects beyond the third transport base edge with a third contact surface 210c and beyond the fourth transport base edge with a fourth contact surface 210d. In the example shown, it is provided that a distance between the first transport base edge 210a and the second transport base edge 210b substantially corresponds to an inner distance between the second side walls 301 and a distance between the third transport base edge 210c and the fourth transport base edge 210d corresponds to an inner distance between the first side walls 201 By doing so, the transport base 202 of a second tray 1 can be received between the first side walls 201 and the second side walls 301 of a first tray 1 when the second tray 1 is stacked on the first tray 1. In this case, the second tray 1 can rest on the second side walls 301 of the first tray 1 with the first and second contact surfaces 310a, 310b and on the first side walls 201 of the tray 1 with the third and fourth contact surfaces 210c, 210d.

As already described above, the lower part 2 comprises a plurality of lower drainage openings 104a, which are arranged in the transport base 202 and pass therethrough. Although another arrangement is conceivable, the lower drainage openings 104a are preferably arranged around or on the aforementioned intersection points of the upper and lower stiffening ribs 214a, 214b as shown in FIG. 2a and FIG. 2d.

The upper part 3 of the tray 1 is shown in FIG. 3a to FIG. 3d, wherein upper part 3 is shown in perspective view in FIG. 3a, in a side view parallel to the longitudinal axis 103 of the tray 1 in FIG. 3b and in a lower view of the lower side of the transport base 202 in FIG. 3c as well as in FIG. 3d.

The loading base 302 provides a base. The second side walls 301 each form a flange mounted on the base such that the upper part 3 is substantially configured in a U shape. To assemble the tray 1, the lower part 2 and the upper part 3 are put together so as to be rotated substantially by 90° relative to one another, such that the first side walls 201 are arranged along the end sides 101a, 101b and the second side walls 301 are arranged along the longitudinal sides 102a, 102b of the tray 1.

In addition, the loading base 302 forms a first loading edge 311a on the first end side 101a and a second loading edge 311b on the second end side 101b, using which the load 4 can be pushed off when the tray 1 is provided in the transfer configuration.

The loading base 302 preferably has a pusher ramp 312a on the upper side rising from the first loading plane 303a to the first loading edge 311a and can optionally have a second usher ramp 312b rising from the first loading plane 303a to the second loading edge 311b.

As can be seen in FIG. 3a, the second guide elements 304 and the second securing elements 305 can be molded on the loading base 302 to project on the end sides 101a, 101b, in particular parallel to the longitudinal axis 103, of the tray 1. In this case, the second guide elements 304 are configured as a guide projection and the second securing elements 305 are designed as a securing projection, which are positioned such that they can engage into the first guide elements 204 and first securing elements 205.

The second side walls 301 extend along the longitudinal sides 102a, 102b of the tray 1 and parallel to the longitudinal axis 103 of the tray 1. In this case, the second side walls 301 are dimensioned such that they extend between the longitudinal portions 212a, 212b of the first side walls 201 as can be seen in particular from FIG. 1a. At opposite ends of the second side walls 301, the second side walls 301 each form a second inclined surface 313 which extends between the lower edge 308 and the upper edge 307 of the respective second side wall 301. As can be seen in particular in FIG. 3b, the second inclined surface 313 forms an (acute) angle β with an imagined plane parallel to the transport base 202, said angle is approximately 50° in the example shown. Of course, the angle β can be selected as desired, in particular from 0° to 90°. It is expedient if the angles α and β are selected such that the sum of the angles is equal to 180°. By doing so, it can be achieved that the second oblique surfaces 313 each rest on a first inclined surface 213 in the transport configuration, as can be seen in FIG. 1a.

As described above and indicated by a dashed line in FIG. 3b, the loading base 302 can comprise a lower base 302a and an upper base 302b analogous to the transport base 202.

On the lower side, the loading base 302 can have an outer surface and lower stiffening ribs 314 arranged distributed over the outer surface and protruding from the outer surface, in particular downward or in the direction of the lower part.

Although an arrangement of the lower stiffening ribs 314 of the upper part 3 can be chosen arbitrarily, the lower stiffening ribs 314a in the example shown are arranged such that these form a plurality of intersection points at which these intersect. Preferably, some of the lower stiffening ribs 314 are substantially concentric about a central point and some of the lower stiffening ribs 314 are arranged radially starting from the central point.

In the example shown, the lower stiffening ribs 314 of the upper part 3 and the aforementioned upper stiffening ribs 214a of the lower part 2 are arranged such that they are aligned with one another and rest on one another (at least in sections) in the transport configuration.

However, the stiffening ribs 314 can also be arranged between the lower base 302a and the upper base 302b of the loading base 302 such that the stiffening ribs 314 are covered by the lower base 302a of the loading base 302 in a view from below, as shown in FIG. 3d. In the transport configuration, it is preferably not the upper stiffening ribs 214 and the lower stiffening ribs 314 that rest on one another, but rather the upper base 202b of the transport base 202 and the lower base 302a of the loading base 302.

As already described above, the lower part 3 comprises a plurality of upper drainage openings 104a in the preferred embodiment shown, which are arranged in the transport base 302 and pass therethrough. It is advantageous for the upper drainage openings 104b to be arranged at the intersection points of the lower stiffening ribs 314 of the upper part 3 as shown in FIG. 3c. In this case, it can be provided that the lower drainage openings 104a and the upper drainage openings 104b are aligned with one another in the transport configuration and optionally also in the transfer position.

Furthermore, the upper part 3 can have a plurality of optional side drainage openings 104c, which are arranged in the second side walls 301. Alternatively or additionally, the side drainage openings 104c can be arranged in the first side walls 201 or the tray 1 can be configured without side drainage openings 104c.

The upper part 3 comprises a first receiving compartment, which is provided by the first loading plane 303a. The first loading plane 303a extends between the end sides and is configured to receive a single load 4 or a plurality of loads 4. If a plurality of load items 4 are to be received on the loading plane 303a, these can be placed in a row one behind the other and between the second side walls 301.

In addition, the upper part 2 can comprise a second receiving compartment with a second loading plane 303b as per the example shown.

If the upper part 2 has a second loading plane 303 it can be provided that the first loading plane 303a is arranged at a first height level and the second loading plane 303b at a second height level (different from the first height level), wherein the first loading plane 303a is delimited in a (first) loading width d1 by first stop edges 315a aligned parallel to one another and substantially vertical to the first loading plane 303a. Furthermore, the second loading plane 303b is delimited in a wider (second) loading width d2 by second stop edges 315b running parallel to one another and aligned vertically to the second loading plane 303b. The wider (second) loading width d2 is configured to be larger than the (first) loading width d1.

The first stop edges 315a are formed by mutually spaced, parallel support pads 316 extending between the end faces, which are arranged on the upper side of the loading base 302. The support pads 316 protrude at the first loading plane 303a. The second stop edges 315b can be formed by the second side walls 301 as depicted in the embodiment shown. According to the embodiment shown, the first loading plane 303a substantially forms a first loading surface provided by the upper side of the loading base 302. The second loading plane 303b can be formed by a second loading surface formed on the support pads 316. In the exemplary illustration, the second loading surface is formed on the end edges of the support pads 316 facing away from the first loading plane 303a and running parallel to one another. Of course, more than two receiving compartments, in particular at least one further receiving compartment with a further loading plane, can be provided in the same way. In this case, it can be provided that the further loading plane of the at least one further receiving compartment is arranged at a further height level lying between the first height level and the second height level. By analogy to the first receiving compartment, the at least one further receiving compartment can be delimited by further stop edges.

FIG. 4a and FIG. 4b correspond to a sectional view of the tray 1 along the section line IV-IV drawn in FIG. 1a and FIG. 1b, wherein the tray 1 is shown in the transport configuration in FIG. 4a by analogy to FIGS. 1a and 1n the transferring configuration in FIG. 4b by analogy to FIG. 1b.

In the transport configuration shown in FIG. 4a, the loading base 302 is in a transport position at a first distance from the transport base 202. The first distance is substantially zero millimeters in the example shown. This means that the loading base 302 rests on the transport base 202, at least in sections, in particular in support sections. Specifically, the lower stiffening ribs 314 of the upper part 3 rest on the upper stiffening ribs of the lower part 2 in the example shown, as can be seen in FIG. 4a. The second guide member 304, which protrudes from the loading base 302, engages the first guide member 204, which is arranged in the first side wall 301. The (first and/or second) loading edge 311a, 311b lies below the upper edge 207 of the first side walls 201.

In the transferring configuration shown in FIG. 4b, the loading base 302 is in a transferring position at a second distance from the transport base 202. The second distance is greater than the first distance. In the transferring configuration, the second guide element 304 is also in engagement with the first guide element 204. The (first and/or second) loading edge 311a, 311b is substantially aligned with the upper edge 207 of the second side walls 301. In this case, the loading base 302 can, optionally in regions, project beyond the upper edge 307 of the second side walls 301, in particular with the support pads 316 as can be seen in FIG. 4b.

As shown in the example, the first loading plane 303a can lie below an imagined cover plane running parallel to the transport base 202 through the upper edge 207, wherein a height difference between the first loading plane 303a and the upper edge 307 of the first side walls 201 is bridged by the pusher ramp 312a, 312b. As shown, the second loading plane 303b can be above the imagined cover plane.

FIGS. 5a to 5e show a perspective view of an automated unloading device 5 for unloading a tray 1 loaded with loads 4. In this case, the unloading device 5 is shown for various method steps of a method for unloading the tray 1. In FIG. 6a and FIG. 6b, the unloading device 5 is shown in sectional view.

The unloading device 5 comprises a provisioning location 6, on which a tray 1 loaded with loads 4 can be provided, as shown in FIG. 5b, FIG. 5c and FIG. 6a, for example. Adjoining the provisioning location 6, the unloading device 5 has a transfer location 7, onto which the load 4 can be pushed off the tray 1 as shown in FIG. 5d and FIG. 6b, for example.

In addition, the unloading device 5 comprises a tray conveying system with an automated tray conveying device 8 and a load conveying system with an automated load conveying device 10.

Furthermore, the unloading device 5 has a positioning system, an actuating device for moving the tray 1 between the transport configuration and the transferring configuration and a transfer device 18 for pushing the load 4 from the tray 1 onto the transfer location 7. The actuating device and the transfer device 18 are arranged in the region of the provisioning location 6.

Furthermore, the unloading device 5 can have a schematically illustrated electronic control device 25, which is configured to actuate the tray conveying device 8, the load conveying device 10, the positioning system, the actuating device and/or the transfer device.

The tray conveying system comprises an automated tray conveying device 8, which defines a tray conveying plane (TE). The tray conveying device 8 comprises a first tray conveying section 9a for transporting the tray 1 to the provisioning location 6, a second tray conveying section 9b adjoining the first tray conveying section 9a for providing the tray 1 at the provisioning location 6 and a third tray conveying section 9c for transporting the tray 1 from the provisioning location 6. In the example shown, the tray conveying device 8 forms the provisioning location 6 in the second tray conveying section 9b. The tray conveying device 8 is configured to transport the tray 1 in a tray conveying direction illustrated by an arrow in the tray conveying system in FIGS. 5a to 5e. In the example shown, the first and second tray conveying sections 9a, 9b and the second and third tray conveying sections 9b, 9c each form an angle of 90°, wherein the third tray conveying section 9c is aligned in the opposite direction to the first tray conveying section 9a. This results in a particularly space-saving U shaped circumference of the tray 1. Of course, the tray conveying sections can form any desired angle with one another. In this case, it can particularly be provided that the first and second tray conveying sections 9a, 9b and the second and third tray conveying sections 9b, 9c each form an angle of 180° to one another, thus resulting in a rectilinear transport of the tray 1.

The load conveying system comprises an automated load conveying device 10, which defines a load conveying plane (LE). As can be seen in particular in FIG. 6a and FIG. 6b, the load conveying plane (LE) is arranged at a different, in particular higher, height level to the tray conveying plane (TE). In this case, the second distance between the lower part 2 and the upper part 3 as well as the (first and/or second) pusher ramp 312a, 312b of the tray 1 bridge a height difference between the load conveying plane (LE) and the tray conveying plane (TE) when the tray 1 is provided in the transferring configuration on the provisioning location 6.

Furthermore, the load conveying device 10 comprises a load conveying portion for transporting the load 4 away from the transfer location 7. In this case, the load 4 is transported in a load-conveying direction illustrated by an arrow in the load conveying device 10 in FIGS. 5a to 5e. In the example shown, the load conveying device 10 forms the provisioning location 6.

The positioning system has a drive device 12 and a stop element 11 that can be moved by the drive device 12 between a starting position shown in FIG. 5e and a positioning position shown 5a. The stop element 11 is (completely) below the tray conveying plane (TE) in the starting position and the stop element 11 projects beyond the tray conveying plane (TE) in the positioning position. The stop element 11 is a stop plate, for example. In order to bring the tray 1 into a provisioning position, the tray 1, in particular with the longitudinal portions 212, 212a, can be positioned against the stop element 11, in particular against a first stop surface 13a and a second stop surface 13b of the stop element 11 as shown in FIG. 7a and FIG. 7b when the stop element 11 is in the positioning position.

The actuating device comprises a drive device 15 and a first support element 14a for receiving the upper part 3 in a first edge region of the upper part 3 and a second support element 14b, in particular downstream of the first support element 14a in the tray conveying direction, for receiving the upper part 3 in a second edge region of the upper part 3. The first support element 14a and the second support element 14b can be (synchronously) moved by the drive device 15 between a starting position shown in FIG. 5a, FIG. 5e and FIG. 6a, in which the support elements lie below the tray conveying plane (TE), and a lifting position shown in FIG. 5c, FIG. 5d and FIG. 6b, in which the support elements project beyond the tray conveying plane (TE). The first support element 14a 14a and the second support element 14b are arranged at a first distance from one another, the first distance substantially corresponding to a distance between the first transport base edge 210a and the second transport base edge 210b, such that the first support element 14a can be placed against the first contact surface 310a of the tray 1 and the second support element 14b can be placed against the second contact surface 310b of the tray 1 in the lifting position.

The first support element 14 and the second support element 14b are each configured as a support plate, for example. In order to achieve a joint, in particular synchronous movement of the first support element 14a and the second support element 14b by means of the drive device 15, these can be mounted on a joint lifting frame.

Furthermore, the actuating device comprises a third support element for receiving the lower part 2. The third support element can be provided by the tray conveyor 8 as provided in the example shown. In order to fix the lower part 2 of the tray 1 in the provisioning location, the third support element can have clamping means (not shown), which can be placed against the first side walls 201 of the tray 1, for example.

The stop element 11 and the second support element 14b are shown in a plan view in FIGS. 7a and 7b. For clarity, the tray conveying device 8 is not shown. As can be seen in FIG. 7a and FIG. 7b, a tray 1 is transported in the tray conveying direction indicated by an arrow in FIG. 7a and positioned against the stop element 11.

The second support element 14b is arranged downstream of the first support element 14a in the tray conveying direction and comprises a front surface 16a facing the first support element 14a and a rear surface 16b facing away from the first support element 14a. As can be seen in FIG. 7a, the first and second stop surfaces 13a, 13b are arranged in alignment with the rear surface 16b of the second support element 14b.

As shown in FIG. 7b, the tray 1 with the first longitudinal portions 212a of the first side walls 201 can be positioned against the stop surfaces 13a, 13b of the stop element 11. As a result, the second contact surface 310b can be positioned above the second support element 14b. Since a distance between the first support element 14a and the second support element 14b corresponds to a distance between the first and the second transport base edge 210a, 210b, the first contact surface 310a of the upper part 3 is arranged above the first support element 14a. The tray 1 can then be moved from the transport configuration to the transferring configuration, for example, by an upward movement of the first and second support elements 14a, 14b, as shown in FIG. 6a and FIG. 6b.

As can be seen in FIG. 5a to FIG. 5e, the unloading device 5 can have a monitoring device 17 for detecting a transfer of at least one load 4 from the tray 1 to the transfer location 7. The monitoring device 17 comprises a sensor system, for example a light barrier. The control device 25 is connected to the monitoring device 17 and actuates the transfer device 18 to push a load 4 from the tray (load carrier) to the transfer location 7.

The transfer device 18 comprises a pusher 20 movable relative to the tray conveying device 8 in a push-off direction 22 and mounted on a base frame 19. The pusher 20 is arranged above the tray conveying device 8 and forms a pushing surface 21 that can be placed against the load 4. In this case, the push-off direction 22 is orthogonally aligned with the tray conveying direction and preferably parallel to the load conveying direction.

In order to push a load 4 from the tray 1 to the transfer location 7 the pusher 20 is moved from a resting position shown in FIG. 5a, FIG. 5b and FIG. 6a by a specific movement path in the push-off direction 22 into an unloading position shown in FIG. 5d and FIG. 6b. For this purpose, the pusher 20 is mounted on an adjustment carriage 24, which can be moved along a guide assembly 23 by a drive device.

The drive device is connected to the control device 25 schematically illustrated in FIG. 5a to FIG. 5e. The control device 25 actuates the drive device such that the pusher 20 is moved from the resting position into the unloading position in order to push a load 4 or a plurality of loads 4 from the tray 1 to the receiving location 7 as a load group.

The unloading position or the movement path is dependent on a measurement of a load 4 to be pushed off or of a load group to be pushed off and/or on a number of loads 4 to be pushed off. The control device 25 calculates the movement path for the pusher 20, wherein the pusher 20 has reached the unloading position when the load 4 or the corresponding number of loads 4 has been pushed (completely) from the tray 1 onto the transfer location 7.

As can be seen in FIG. 6a and FIG. 6b, the drive device can comprise a traction drive 26 connected to the adjustment carriage 24. The traction drive 26 comprises an endlessly rotating traction mechanism, which is guided around a deflection wheel, and a drive wheel coupled to an electric actuator 27. By rotating the drive wheel clockwise or counterclockwise, the adjustment carriage 24 and the pusher 20 mounted thereon are moved relative to the tray conveying device 8 and thus relative to the tray 1 along, in particular in or counter to, the push-off direction 22.

According to a preferred embodiment, the pusher 20 can be moved by a drive device 28 in a (vertical) movement direction 29 between a starting position shown in FIG. 5a, FIG. 5b, FIG. 5e and FIG. 6a into an engagement position shown in FIG. 5c, FIG. 5d and FIG. 6b.

The transfer device 18 can optionally comprise a path measuring device (not shown), by means of which a displacement motion of the slider 20 is detected. The path measuring device is connected to the control device 25. The path measuring device is preferably formed by a capacitive displacement transducer, inductive displacement transducer, magnetic displacement transducer or optoelectronic displacement transducer known per se. These use the measurement method of absolute and incremental path measurement. For example, the actuator 27 can be provided with a resolver, incremental transducer, or absolute transducer.

The method for unloading the tray 1 is shown schematically in FIG. 8.

In this case, in a first unloading step E1, a tray 1 loaded with load 4 is transported by the tray conveying device 8 as shown in FIG. 5a via the first and second tray conveying sections 9a, 9b to the provisioning location 6 and is provided there.

In a second unloading step E2, the tray 1 is positioned by the positioning system and provided in the provisioning position. As described above, the stop element 11 is moved from the starting position into the positioning position and the tray 1 is positioned against the stop element 11.

When the tray 1 is positioned in the provisioning position and optionally fixed therein by the clamping means, the tray 1 is moved from the transport configuration into the transferring configuration in a third unloading step E3. This is carried out by the actuating device. In this case, the first support element 14a and the second support element 14b are moved from the starting position into the lifting position as described above, wherein the first support element 14a is placed against the first contact surface 310a and the second support element 14b is placed against the second contact surface 310b. As a result, the upper part 3 is lifted relative to the lower part 2, as shown in FIG. 5c and FIG. 6b, for example.

In a fourth unloading step E4, one or more loads 4 are pushed from the tray 1 via the (first or second) pusher ramp 312a, 312b and the (first or second) loading edge 311a, 311b of the tray 1 onto the transfer location 7. This is carried out by the transfer device 18 as described above. In this case, the pusher 20 is moved from the resting position into the unloading position, wherein the pushing surface 21 is placed against a side surface of the load 4 to be pushed off or one of the loads 4 to be pushed off.

Furthermore, in a fifth unloading step E5, the pushed-off load 4 or the pushed-off loads 4 are transported away from the transfer location 7 by means of the load conveying device 10 and are optionally transported to a manual or automatic order-picking device 65.

In a sixth unloading step E6, the tray 1 is moved from the transferring configuration back into the transport configuration by moving the first support element 14a and the second support element 14b from the lifting position back into the starting position. If the tray 1 was previously fixed by clamping means, this fixing is released again. Subsequently, in a seventh unloading step E7, the tray 1 is transported away from the provisioning location 6 by the tray conveying device 8. The sixth unloading step E6 and/or the seventh unloading step E7 can optionally be carried out simultaneously or overlapping in time with the fifth unloading step E5.

Of course, the stop element 11 is moved back out of the positioning position into the starting position before the sixth unloading step E6. This can be done at any time before the sixth unloading step E6 and after the second unloading step E2.

In FIG. 9a, a loading device 30 for loading a tray 1 with a load 4 is shown schematically. Furthermore, a perspective view of a partial section of the loading device is shown in FIG. 9b.

The loading device 30 comprises a load conveying system with a load conveying device 31 for conveying loads 4, which defines a load conveying plane (LE), and a tray conveying system with a tray conveying device 32 for conveying trays 1, which defines a tray conveying plane (TE). As can be seen in FIG. 9a, the tray conveying plane (TE) is arranged at a first height level and the load conveying plane (LE) at a second height level, wherein the first height level is below the second height level. The load conveying device 31 and the tray conveying device 32 convey the load 4 or the tray 1 in a conveying direction 33.

Furthermore, the load conveying system shown comprises a measuring device 34 for acquiring the load 4 and a position changing device 35, with which a pose of the load 4 can be changed.

The position changing device 35 can have a tilting device 36 and a rotation device 38 as in the example shown. In addition, the position changing device 35 can comprise a grouping device 41 for forming a load group from a plurality of loads 4 and/or an alignment device 43 for positioning the loads 4 on the load conveying device 31.

As can be seen in FIG. 9a, the measuring device 34, the tilting device 36, the rotation device 38 and the aligning device 43 are arranged in succession in the conveying direction 33. In the example shown, the grouping device 41 is formed in the region of the alignment device 43 by a storage region on the load conveying device 31.

The loading device 30 further comprises a transfer system adjoining the load conveying system in the conveying direction 33 and is configured to transfer load 4 from the load conveying system and transfer it to a tray 1 provided on the transfer system.

In the example shown, the load conveying device 31 is configured to transport the load 4 in the conveying direction 33 from the position changing device 35 to the transfer system. For this purpose, the tray conveying device 32 is configured to transport a tray 1 in the conveying direction to the transfer system and to provide it at the transfer system.

Furthermore, the loading device 30 comprises a control device 50 for controlling the position change device 35, the load conveying system, the transfer system and/or the tray conveying system, a processing system 51 for determining a loading pose with which the load 4 is to be loaded onto the tray 1 a load acquisition system 52, which optionally comprises the measuring device 34 and a tray acquisition system 53.

In the example shown, a computer system 54 is provided comprising the load acquisition system 52, the tray acquisition system 53 and the processing system 51.

The measuring device 34 comprises a sensor system for detecting the load 4. One the one hand, the sensor system can be configured to detect the dimensions of the load 4. The sensor system can have a camera system for this purpose. In this case, the dimensions of the load can be determined by an algorithm for image recognition, for example. Alternatively, the sensor system can have one or more light barriers or a light curtain or a light grid for acquiring the dimensions of the load.

On the other hand, the sensor system can be configured to identify the load 4 wherein the load dimensions of the load 4 are stored in an electronic memory, for example, and can be accessed by the load acquisition system 52. The sensor system can comprise a reader for acquiring a machine-readable code arranged on the load 4. The machine-readable code can be a barcode, a QR code or an RFID tag, for example.

The tilting device 36 preferably comprises a first tilting arm 37a and a second tilting arm 37b, which form a right angle and which are rotatable about a horizontal axis of rotation in order to tilt the load 4. The tilting arms 37a, 37b can be configured in the shape of a comb and extend across a width of the conveying plane.

As can be seen in particular in FIG. 9b, the rotation device 38 preferably comprises a plurality of driven conveying elements 39 as well as a lifting and rotating platform 40. The lifting and rotating platform 40 can be moved by a drive device (not shown) between a starting position located below the load conveying plane (LE) and a lifting position located above the load conveying plane (LE) and can be rotated by a further drive device (not shown) about an axis of rotation aligned orthogonally to the load conveying plane (LE). The lifting and rotating platform 40 further comprises a plurality of openings, through which the conveying elements 39 protrude when the lifting and rotating platform 40 is positioned in the starting position.

In order to rotate the load 4, this is positioned above the lifting and rotating platform 40 by the conveying elements 39. By moving the lifting and rotating platform 40 from the starting position into the lifting position, the load 4 is lifted above the load conveying plane (LE). Subsequently, the load 4 can be rotated about the axis of rotation by rotating the lifting and rotating platform 40, in particular by 90°, 180°, 270° or 360°. If the load 4 is in the desired alignment, the load 4 can be transferred back to the conveyor elements 39 by lowering the lifting and rotating platform 40 from the lifting position into the starting position and is further transported by the conveyor elements 39. The lifting and rotating platform 40 is preferably configured to be rotationally symmetrical about the axis of rotation for this purpose.

The grouping device 41 comprises a drive device (not shown) and stop elements 42a . . . 42c that can be moved between a starting position and a grouping position, in particular independently of one another, by the drive device. The drive device can have a drive for each stop element 42 . . . 42c for this purpose. The respective stop element 42a . . . 42c is (completely) below the load conveying plane (LE) in the starting position, and the respective stop element 42a . . . 42c projects beyond the load conveying plane (LE) in the grouping position. In the example shown, the grouping device 41 has a first stop element 42a, a second stop element 42b and a third stop element 42c, which can selectively be brought from the starting position into the grouping position depending on load dimensions and/or the number of loads to be grouped. The stop elements 42a . . . 42c are each a stop plate, for example.

In the example shown, the alignment device 43 comprises a first pusher 44a and a second pusher 44b. The pushers 44a, 44b are mounted on a base frame 45 so as to be movable relative to the load conveying device 31 orthogonal to the conveying direction 33. The pushers 44a, 44b can be moved by means of a drive device from a starting position moved apart from one another into a centering position moved toward one another in order to center the load 4 on the load conveying device 31. In this case, the drive device can be designed analogously to the drive device of the transfer device 18 and can comprise a traction drive. The traction drive comprises an endlessly rotating traction mechanism, which is guided around a deflection wheel and a drive wheel coupled to an electric actuator 46.

The transfer system comprises a transfer conveying device 47, which provides an inclined transfer conveying plane to bridge a height difference between the load conveying plane (LE) and the tray conveying plane (TE). The transfer conveying device 47 is preferably configured as a knife edge conveyor.

In this case, the inclined transfer conveying plane extends between a transfer edge 48 adjoining the load conveying device 31 and is aligned orthogonally to the conveying direction 33, and a transfer edge 49 above the tray conveying device 32 and aligned orthogonally to the conveying direction 33. The transfer edge 49 is arranged orthogonally to the tray conveying plane (TE) at a distance therefrom, which makes possible, on the one hand, for a tray 1 to be provided or conveyed between the transfer edge 49 and the tray conveying plane and, on the other hand, for a load 4 to be transferred from the transfer conveying device 47 onto the tray 1.

Between the transfer edge 48 and the transfer edge 49, the transfer conveying device 47 comprises a propulsion means for constant propulsion of the load 4. The propulsion means is provided by a circulating conveyor belt in the example shown. Alternatively, the propulsion means can also be provided by a plurality of conveyor rollers or the like.

On the one hand, the tray 1 is provided by the tray conveying device 32 with constant propulsion below the transfer edge 49 for loading the tray 1 and, on the other hand, the load 4 is provided by the load conveying device 31 at the upper edge and transferred onto the tray 1. For this purpose, the tray conveying device 32 and the transfer conveying device 47 are actuated by the control device 50 such that the load 4 or the loads 4, that are to be loaded onto the tray 1, and the tray 1 are simultaneously provided at the transfer edge 49.

When loading a tray 1 with a load 4 or a plurality of loads 4, in particular with the aforementioned loading device 30, as shown schematically in FIG. 10, the load 4 is transported to the loading device 30 in a first loading step B1. In a second loading step B2, the tray 1 is transported to the loading device 30.

Furthermore, in a third loading step B3, the load dimensions are acquired by the load acquisition system 52 and the loading width d1, d2 of the tray 1 is acquired by the tray acquisition system 53 and transmitted to the processing system 51. The loading width d1, d2 can particularly comprise the aforementioned first loading width d1 and/or second loading width d2.

Subsequently, in a fourth loading step B4, a loading pose is determined by the processing system 51 and a control specification 59 for the position changing device 35 is generated. The control specification 59 is transmitted to the control device 50, which controls the position changing device 35 such that the load 4 is brought into the loading pose by the position changing device 35, in particular by the tilting device 36 and/or the rotation device 38. The load 4 is preferably conveyed by the load conveying device 31 from the rotation device 38 to the grouping device 41 and to the alignment device 43. If a plurality of loads 4 are to be loaded onto the tray 1 as a load group, the load 4 is stored in the grouping device 41 as necessary, in particular until all loads 4 of the load group are present in the grouping device 41 and the preceding loading steps B1 . . . . B4 are repeated one to four for at least one further load of the load group.

Furthermore, the load 4 or the load group is positioned relative to the tray 1 by an alignment device 43 in a fifth loading step B5 on the load conveying device 31 in particular so that the load 4 can be transferred centrally onto the tray 1. In a sixth loading step B6, the tray 1 is provided at the transfer device 18 and the load 4 or the load group is transferred by the transfer device 18 and transferred onto the tray 1 as described above. The loaded tray 1 is transported away from the transfer device 18 in a seventh loading step B7.

FIG. 11 schematically illustrates an embodiment of a computer-implemented method for controlling 60 the position changing device 35.

To carry out the method, the aforementioned computer system 54 can be provided, which comprises the processing system 51, the load acquisition system 52, the tray acquisition system 53 and an electronic memory 55.

In this case, load dimensions are acquired by the load acquisition system 52 in a first step. It is preferably provided that the load 4 is identified by the measuring device 34 as described above, wherein identification data 56 are acquired by the measuring device 34 and transmitted to the load acquisition system 52. Load data 57 stored for the load 4 are accessed in the electronic memory 55 using the identification data 56, wherein the load data 57 comprise the load dimensions. The load 4 can also optionally be identified from a known load sequence, in particular predefined by a material flow. The load data 57 or the load dimensions are transmitted from the load acquisition system 52 to the processing system 51.

Alternatively, the load dimensions can be acquired by the measuring device 34 and transmitted to the load acquisition system 52 as also described above. In this case, the load data 57 comprising the load dimensions are generated by the load acquisition system 52 and transmitted to the processing system 51.

In a second step, which can take place substantially temporally parallel to the first step, the loading width d1, d2 of the tray 1 is acquired by the tray acquisition system 53. In this case, tray data 58 are accessed in the electronic memory 55 by the tray acquisition system 53 and transmitted from the tray acquisition system 53 to the processing system 51. The tray data 58 comprise the loading width d1, d2, in particular the first loading width d1 and the second loading width d2.

Subsequently, the processing system 51 compares the load dimensions with the loading width d1, d2, wherein a side surface of the load 4 is determined, whose surface diagonal is greater than the loading width d1, d2, for example.

The processing system 51 determines a loading pose on the basis of a comparison of the load dimensions with the loading width d1, d2. The loading pose indicates the side surface on which the load 4 will rest and the orientation in which the load 4 will be loaded onto the tray 1.

For example, as shown in FIG. 12a, the loading pose can specify that the load 4 should rest on that side surface whose surface diagonal is greater than the loading width d1, d2 and whose length and/or width is less than the loading width d1, d2 and should be aligned with a longitudinal edge parallel to the longitudinal axis 103 of the tray 1, since in this case a rotational movement of the load 4 on the tray 1 is limited by the first loading width d1. Of course, different loading poses are also possible for different loads 4 and loading requirements.

For example, if a plurality of loads 4 are to be transferred to a tray 1, it can be provided that the loading pose specifies that the loads 4 are each to be aligned with a longitudinal edge orthogonal to the longitudinal axis 103 of the tray 1 as shown in FIG. 12b. In this case, the rotational movement of the loads 4 is limited by the second loading width d2.

In a next step, a control specification 59 for the control device 50 for controlling the position changing device 35 is generated by the processing system 51 on the basis of the loading pose and transmitted from the processing system 51 to the control device 50.

On the basis of the control specification 59, a control 60 of the position changing device 35 is carried out by the control device 50 such that the load 4 is brought into the loading pose by the position changing device 35, in particular by rotating and/or tilting the load 4 as described above.

Finally, FIG. 13 schematically shows an order-picking system 61. The order-picking system 61 comprises an incoming storage 62, a depalletizing device 63, a loading device 30, a tray storage 64 for load 4, an unloading device 5 and an order-picking device 65.

The incoming storage 62 can be configured as a manual store, semi-automated storage or fully automated storage. In the incoming storage 62, the loads 4 are delivered on storage structures, for example pallets, containers and the like, and stored on storage racks. The storage structures can be unloaded by the depalletizing device 63, wherein the loads 4 are separated.

The loads 4 can be transported to the loading device 30 by means of an automated load conveying device 31. The loads 4 can be loaded onto trays by means of the loading device 30 as described above.

The loads 4 are then stored on the trays 1 in the tray storage 64 for loads 4.

If a load 4 is required for a picking order, the tray 1 with the corresponding load 4 can be retrieved from the tray storage 64 and transported to an unloading device 5 by means of a tray conveying device 8. The unloading device 5 allows the load 4 to be unloaded from the tray 1 as described above. The load 4 can then be transported to the order-picking device 65 by means of the load conveying device 10. According to the picking order, an order load carrier, for example a roll container or a pallet, can be loaded with loads at the order-picking device 65. In this case, the loads 4 are preferably stacked on the order load carrier.

Finally, it is further stated that the scope of protection is determined by the claims. However, the description and the drawings are to be referenced for the interpretation of the claims. Individual features or combinations of features from the various exemplary embodiments shown and described can represent independent inventive solutions in themselves.

It is also particularly stated that the devices shown can, in reality, also comprise more or even fewer components than those shown. In some cases, the devices shown or their components have not been shown to scale and/or enlarged and/or shrunk.

List of reference numerals

| | | | |
|---|---|---|---|
| | | 314 | Stiffening ribs |
| 1 | Tray | 315a, 315b | Stop edges |
| 101a, 101b | End side | 316 | Support pads |
| 102a, 102b | Longitudinal side | 317 | Opening |
| 103 | Longitudinal axis | | |
| 104a . . . 104c | Drainage openings | 4 | Load |
| | | 5 | Unloading device |
| 2 | Lower part | 6 | Provisioning location |
| 201 | First side walls | 7 | Transfer location |
| 202 | Transport base | 8 | Tray conveying device |
| 202a | Lower base | 9a . . . 9c | Tray conveying section |
| 202b | Upper base | 10 | Load conveying device |
| 203 | Transport surface | | |
| 204 | First guide element | 11 | Stop element |
| 205 | First securing element | 12 | Drive device |
| 206a, 206b | Stacking element | 13a, 13b | Stop surface |
| 207 | Upper edge | | |
| 208 | Lower edge | 14a, 14b | Support element |
| 209 | Recess | 15 | Drive device |
| 210a, 210b | Transport base edge | 16a | Front surface |
| 210c, 210d | Contact surface | 16b | Rear surface |
| 211 | End portion | | |
| 212a, 212b | Longitudinal portion | 17 | Monitoring device |
| 213 | First inclined surface | | |
| 214a, 214b | Stiffening ribs | 18 | Transfer device |
| 215 | Engagement opening | 19 | Base frame |
| 216 | Transport bevel | 20 | Pusher |
| 217 | Projection | 21 | Pushing surface |
| 218 | Cover | 22 | Pushing direction |
| | | 23 | Guide assembly |
| 3 | Upper part | 24 | Adjustment carriage |
| 301 | Second side walls | 25 | Control device |
| 302 | Loading base | 26 | Traction drive |
| 302a | Lower base | 27 | Actuator |
| 302b | Upper base | 28 | Drive device |
| 303a, 303b | Loading plane | 29 | Movement direction |
| 304 | Second guide element | | |
| 305 | Second securing element | 30 | Loading device |
| 306a, 306b | Stacking element | 31 | Load conveying device |
| 307 | Upper edge | 32 | Tray conveying device |
| 308 | Lower edge | 33 | Conveying direction |
| 309 | Recess | 34 | Measuring device |
| 310a, 310b | Contact surface | | |
| 311a, 311b | Loading edge | 35 | Position changing device |
| 312a, 312b | Pusher ramp | 36 | Tilting device |
| 313 | Second inclined surface | 37a, 37b | Tilting arm |
| 38 | Rotation device | B4 | Fourth loading step |
| 39 | Conveying element | B5 | Fifth loading step |
| 40 | Lifting and rotating platform | B6 | Sixth loading step |
| | | B7 | Seventh loading step |
| 41 | Grouping device | | |
| 42a . . . 42c | Stop element | | |
| 43 | Alignment device | | |
| 44a, 44b | Pusher | | |
| 45 | Base frame | | |
| 46 | Actuator | | |
| 47 | Transfer conveying device | | |
| 48 | Transfer edge | | |
| 49 | Transfer edge | | |
| 50 | Control device | | |
| 51 | Processing system | | |
| 52 | Load acquisition system | | |
| 53 | Tray acquisition system | | |
| 54 | Computer system | | |
| 55 | Electronic memory | | |
| 56 | Identification data | | |
| 57 | Load data | | |
| 58 | Tray data | | |
| 59 | Control specification | | |
| 60 | Control | | |
| 61 | Order-picking system | | |
| 62 | Incoming storage | | |
| 63 | Depalletizing device | | |
| 64 | Tray storage | | |
| 65 | Order-picking device | | |
| TE | Tray conveying plane | | |
| LE | Load conveying plane | | |
| α, β | Angle | | |
| d1, d2 | Loading width | | |
| E1 | First unloading step | | |
| E2 | Second unloading step | | |
| E3 | Third unloading step | | |
| E4 | Fourth unloading step | | |
| E5 | Fifth unloading step | | |
| E6 | Sixth unloading step | | |
| E7 | Seventh unloading step | | |
| B1 | First loading step | | |
| B2 | Second loading step | | |
| B3 | Third loading step | | |

1. A tray (1) for transporting a load (4) in an order-picking system (61) having
four side walls (201, 301),
a lower part (2) comprising a transport base (202), and
an upper part (3), which comprises a loading base (302) for receiving a load (4) and is mounted on the lower part (2) so as to be movable relative to the transport base (202),
wherein the transport base (202) comprises an upper side facing the upper part (3), a lower side facing away from the upper part (3) and a transport surface (203) on the lower side, and
wherein the loading base (302) comprises a lower side facing the lower part (2), an upper side facing away from the lower part (2), and a first loading plane (303a) on the upper side, and
wherein the tray (1) has a transport configuration, in which the loading base (302) is arranged in a lower transport position and the load (4) can be positioned between the side walls (201, 301), and a transferring configuration, in which the loading base (302) is arranged in an upper transferring position and the load (4) can be pushed from the loading base (302),
wherein
the lower part (2) comprises two of the four side walls, which form first side walls (201) and project upwards from the transport base (202), and
the upper part (3) comprises two of the four side walls, which form second side walls (301) and project upwards from the loading base (302).

2. The tray (1) according to claim 1, wherein
the first side walls (201) are opposite one another and are arranged parallel to one another at a distance from one another, and/or
the second side walls (301) are opposite one another and are arranged parallel to one another at a distance from one another.

3. The tray (1) according to claim 1, wherein the first side walls (201) comprise
an end portion (211), which extends along an end side (101a, 101b) of the tray (1),
a first longitudinal portion (212a), which orthogonally adjoins a first end of the end portion (211) and extends along a first longitudinal side (102a) of the tray (1), and
a second longitudinal portion (212b), which orthogonally adjoins a second end of the end portion (211) opposite the first end and extends along a second longitudinal side (102b) of the tray (1) opposite the first longitudinal side (102a), wherein the second side walls (301) each extend between two longitudinal portions (212a, 212b).

4. The tray (1) according to claim 1, wherein
the first side walls (201) adjoin one another and form a right angle, and
the second side walls (301) abut one another and form a right angle.

5. The tray (1) according to claim 1, wherein, in the transferring position, the loading base (302) is aligned with an upper edge (207) of the first side walls (201) and/or protrudes from an upper edge (207) of the first side walls (201).

6. The tray (1) according to claim 1, wherein the loading base (302) has a pusher ramp (312a,312b) on the upper side rising from the first loading plane (303a).

7. The tray (1) according to claim 1, wherein the transport base (202) has a first transport base edge (210a) aligned orthogonally to the first side walls (201) and a second transport base edge (210b) aligned orthogonally to the first side walls (201), the upper part (3) projecting with a first contact surface (310a) beyond the first transport base edge (210a) and with a second contact surface (310b) beyond the second transport base edge (210b).

8. The tray (1) according to claim 1, wherein the lower part (2) has first guide elements (204) and the upper part (3) has second guide elements (304), the first and second guide elements (204, 304) engaging in a complimentary manner into one another in order to guide the upper part (3) during movement relative to the lower part (2).

9. The tray (1) according to claim 1, wherein the lower part (2) has first securing elements (205) and the upper part (3) has second securing elements (305), the first and second securing elements (205, 305) engaging in a complementary manner into one another and the first securing elements (205) each providing a stop for the second securing elements (305) in order to limit a movement of the upper part (3) relative to the lower part (2).

10. The tray (1) according to claim 1, wherein the lower part (2) and/or the upper part (3) have a plurality of first stacking elements (206a, 306a) and a plurality of second stacking elements (206b, 306b) corresponding to the first stacking elements (206a, 306a).

11. The tray (1) according to claim 1, wherein the transport base (202) has a recess (209) recessed from the lower side of the transport surface (203) in the direction of the upper side of the transport base (202).

12. The tray (1) according to claim 1, wherein the loading base (302) has a recess (309) on the lower side recessed in the direction of the upper side of the loading base (302).

13. The tray (1) according to claim 1, wherein the lower part (2) has
an inner surface at the upper side of the transport base (202) and an outer surface at the lower side,
upper stiffening ribs (214a) distributed over the inner surface and projecting from the inner surface, and/or
lower stiffening ribs (214b) distributed over the outer surface and projecting from the outer surface.

14. The tray (1) according to claim 1, wherein the transport base (202) comprises a lower base (202a) and an upper base (202b) arranged parallel thereto, the lower part (2) having a plurality of upper stiffening ribs (214a), which are accommodated between the lower base (202a) and the upper base (202b).

15. The tray (1) according to claim 1, wherein the upper part (3) has
an outer surface at the lower side of the loading base (302a), and
lower stiffening ribs (314) distributed over the outer surface and projecting from the outer surface.

16. The tray (1) according to claim 1, wherein the loading base (302) has a lower base (302a) and an upper base (302b) arranged parallel thereto, wherein the upper part (3) has a plurality of lower stiffening ribs (314) which are accommodated between the lower base (302a) and the upper base (302b).

17. The tray (1) according to claim 14, wherein the lower base (302a) of the loading base (302) rests on the upper base (202b) of the transport base (202) in the transport configuration of the tray (1).

18. The tray (1) according to claim 1, wherein the transport base (202) has a circumferential transport bevel (216) on the lower side.

19. The tray (1) according to claim 1, wherein the loading base (302) forms the first loading plane (303a) at a first height and a second loading plane (303b) at a second height, wherein the first loading plane (303a) is limited in a first loading width (d1) by first stop edges (315a) running parallel to one another and aligned vertically to the first loading plane (303a) and wherein the second loading plane (303b) is limited in a second loading width (d2) by second stop edges (315b) running parallel to one another and aligned vertically to the second loading plane (303b) and wherein the second loading width (d2) is greater than the first loading width (d1).

20. The tray (1) according to claim 1, wherein the lower drainage openings (104a) are arranged in the transport base (202), upper drainage openings (104b) are arranged in the loading base (302) and/or lateral drainage openings (104c) are arranged in the first side walls (201) and/or in the second side walls (301).

21. The tray (1) according to claim 1, wherein the loading base (302) has a plurality of openings (317) extending through the loading base (302) and wherein the transport base (302) has a plurality of protrusions (217) engaging into the openings (317), wherein the protrusions (217) in the transport configuration of the tray (1) protrude beyond the first loading plane (303a) and in the transferring configuration are flush with the first loading plane (303a) or are recessed in the direction of the transport base (302).

22. The tray (1) according to claim 21, wherein several openings (317) of the openings (317) and several protrusions (217) of the protrusions (217) are arranged in a first row and preferably several openings (317) of the openings (317) and several protrusions (217) of the protrusions (217) are arranged in a second row, wherein the first row and/or the second row is arranged orthogonally to the second side walls (301).

23. An unloading device (5) for unloading the tray (1) according to claim 1 loaded with a load (4),
wherein the tray (1) has four side walls (201, 301), a lower part (2), which comprises a transport base (202), and an upper part (3), which has a loading base (302) for receiving a load (4) and is mounted on the lower part (2) so as to be movable relative to the transport base (202), and
wherein the tray (1) has a transport configuration, in which the loading base (302) is arranged in a lower transport position and the load (4) can be positioned between the side walls (201, 301), and a transferring configuration, in which the loading base (302) is arranged in an upper transferring position and the load (4) can be pushed from the loading base (302),
wherein the unloading device (5) has
a provisioning location (6) for providing the tray (1),
a transfer location (7) for receiving the load (4) from the tray (1), which adjoins the provisioning location (6),
a tray conveying system comprising an automated tray conveying device (8) for transporting the tray (1) to the provisioning location (6) and for transporting the tray (1) away from the provisioning location (6), the automated tray conveying device (8) defining a tray conveying plane (TE),
a load conveying system comprising an automated load conveying device (10) for transporting the load (4) away from the transfer location (7), the automated load conveying device (10) defining a load conveying plane (LE),
a positioning system for positioning the tray (1) in a serving position on the provisioning location (6),
an actuating device for performing a relative movement between the upper part (3) and the lower part (2) of the tray (1) in order to bring the tray (1) from the transport configuration into the transferring configuration, the actuating device being arranged in the region of the provisioning location (6),
a transfer device (18) for pushing the load (4) from the loading base (302) of the tray (1) onto the transfer location (7) when the tray (1) is located at the provisioning location (6) and is provided in the transferring configuration, wherein the transfer device (18) is arranged in the region of the provisioning location (6),
wherein the actuating device has
a first support element (14a) for receiving the upper part (3) in a first edge region of the upper part (3),
a second support element (14b) for receiving the upper part (3) in a second edge region of the upper part (3), and
a third support element for receiving the lower part (2),
wherein the first and second support elements (14a, 14b) for receiving the upper part (3) and the third support element for receiving the lower part (2) are movable relative to each other to provide the tray (1) in the transferring configuration.

24. The unloading device (5) according to claim 23, wherein the first support element (14a) and the second support element (14b) are arranged at a first distance from one another and are preferably aligned parallel to one another.

25. The unloading device (5) according to claim 24, wherein the first support element (14a) and the second support element (14b) are arranged on two longitudinal sides (102a, 102b) of the tray (1) extending in parallel and in alignment with the second side walls (301) of the tray (1) when the tray (1) is in the service position.

26. The unloading device (5) according to claim 23, wherein the first support element (14a) and the second support element (14b) are each configured as a lifting element that can be moved orthogonally to the tray conveying plane (TE).

27. The unloading device (5) according to claim 23, wherein the first support element (14a) and the second support element (14b) are mounted on a lifting frame.

28. The unloading device (5) according to claim 23, wherein the first support element (14a) and the second support element (14b) are movable independently of one another.

29. The unloading device (5) according to claim 23, wherein the third support element is configured as a lifting element that can be moved orthogonally to the tray conveying plane (TE).

30. The unloading device (5) according to claim 23, wherein the transfer device (18) comprises a pusher (20) mounted on a base frame (19) so as to be movable relative to the tray conveyor device (8).

31. The unloading device (5) according to claim 23, wherein the unloading device (5) has a monitoring device (17), in particular a sensor system, for detecting a transfer of a load (4) from the tray (1) to the transfer location (7), wherein a control device (25) is connected to the monitoring device (17) and controls the transfer device (18) in order to push a load (4) from the tray (1) to the transfer location (7).

32. A method for unloading the tray (1) according to claim 1 loaded with a load (4),
which comprises four side walls (201, 301), a lower part (2) with a transport base (202) and an upper part (3) with a loading base (302) for receiving a load (4), wherein the upper part (3) is mounted movably on the lower part (2) in relation to the transport base (202), and wherein the tray (1) has a transport configuration, in which the loading base (302) is arranged in a lower transport position and the load (4) can be positioned between the side walls (201, 301), and has a transferring configuration, in which the loading base (302) is arranged in an upper transferring position and the load (4) can be pushed from the loading base (302),
comprising the steps:
transporting the tray (1) to a provisioning location (6) by a tray conveying system on a tray conveying plane (TE),
positioning the tray (1) in a provisioning position at the provisioning location (6) by a positioning system,
moving the tray (1) from the transport configuration into the transferring configuration by an actuating device by performing a relative movement between the upper part (3) and the lower part (2) of the tray (1),
pushing the load (4) from the loading base (302) to a transfer location (7) by a transfer device (18),
transporting the load (4) away from the transfer location (7) by a load conveying system on a load conveying plane (LE),
moving the tray (1) from the transferring configuration into the transport configuration by the actuating device,
transporting the tray (1) away from the provisioning location (6) by the tray conveying system,
wherein
the upper part (3) of the tray (1) is received during the relative movement by a first support element (14a) and, spaced apart from that, a second support element (14b) of the actuating device in opposing edge regions,
the lower part (2) of the tray (1) is received during the relative movement by a third support element of the actuating device, and
the relative movement is performed by moving the first and second support elements (14a, 14b) and the third support element relatively to one another.

33. The method according to claim 32, wherein the load conveying plane (LE) is arranged at a height level spaced apart from the tray conveying plane (TE), wherein a height difference between the load conveying plane (LE) and the tray conveying plane (TE) is bridged by the relative movement by the actuating device by lifting the upper part (3) when moving the tray (1) from the transferring configuration into the transport configuration.

34. The method according to claim 32, wherein a loading edge (311a, 311b) of the loading base (302) is brought to a height level of the load conveying plane (LE) when moving the tray (1).

35. The method according to claim 32, wherein the transport base (202) has a first transport base edge (210a) and a second transport base edge (210b), wherein the upper part (3) protrudes with a first contact surface (310a) beyond the first transport base edge (210a) and with a second contact surface (310b) beyond the second transport base edge (210b), and for performing the relative movement between the upper part (3) and the lower part (2) the first support element (14a) is contacted from below with the first contact surface (310a) and the second support element (14b) from below with the second contact surface (310b).

36. A computer-implemented method for controlling (60) a position changing device (35) for changing a pose of a load (4) and for the situational positioning of the load (4) by a control device (50), comprising the following steps:
acquiring a loading order for loading a tray (1) with a load (4) by a computer system (51),
acquiring load dimensions by a load acquisition system (52) and transferring the acquired load dimensions from the load acquisition system (52) to the computer system (51),
acquiring a loading width (d1, d2) of the tray (1) by a tray acquisition system (53) and transferring the acquired loading width (d1, d2) from the tray acquisition system (53) to the computer system (51),
comparing the load dimensions with the loading width (d1, d2) by the computer system (51),
determining, by the computer system (51), a loading pose for the load (4) which is to be placed on the tray (1), wherein the loading pose is determined using the load dimensions in such a way that a rotation of the load (4) on the tray (1) is restricted by the loading width (d1, d2),
generating, by the computer system (51), a control specification (59) for controlling (60) the position changing device (35) to bring the load (4) into the loading pose, and
transferring the control specification (59) from the computer system (51) to the control device (50) and control of the position changing device (35) according to the control specification (59) by the control device (50).

37. The method according to claim 36, wherein the acquisition of load dimensions comprises an identification of the load (4) and an accessing of the load dimensions from an electronic memory (55), in particular from a database.

38. The method according to claim 36, wherein the acquisition of the loading width (d1, d2) comprises an accessing of the loading width (d1, d2) from an electronic memory (55), in particular from a database.

39. The method according to claim 36, wherein the acquisition of the loading order comprises an acquisition of a load quantity which specifies how many loads (4) are to be loaded onto the tray (1).

40. The method according to claim 39, wherein the loading pose is determined for all loads (4) which are to be loaded onto the tray (1).

41. The method according to claim 39, wherein the load quantity is considered when determining the load pose.

42. The method according to claim 39, wherein when determining the loading pose, the loads (4) to be loaded onto the tray (1) are combined into a load group, and dimensions of the load group are calculated according to which the loading pose for each load (4) of the load group is determined based on the dimensions of the load group.

43. The method according to claim 36, wherein when acquiring the loading width (d1, d2) of the tray (1) a first loading width (d1) and a second loading width (d2) are acquired, wherein the loading pose is selectively determined for the first loading width (d1) and/or the second loading width (d2).

44. The method according to claim 36, wherein at least one further loading pose is determined and said loading pose is selected with which a highest packing density on the tray (1) is achieved.

45. A loading device (30) for loading the tray (1) according to claim 1 with a load (4),
wherein the tray (1) comprises a first receiving compartment which forms a first loading plane (303a) at a first height level and is configured with a loading width (d1),
wherein the loading device (30) comprises
a transfer system for transferring the load (4) onto the tray (1),
a load conveying system for transporting the load (4) to the transfer system,
a tray conveying system for transporting to and providing the tray (1) at the transfer system,
a position changing device (35) for changing a pose of the load (4) and for situational positioning of the load (4) which is arranged along the load conveying system, and
a control device (50) which controls the position changing device (35) for changing a pose of the load (4) and positioning of the load (4), and
wherein the transfer system is configured for receiving the load (4) by the load conveying system and transferring the load (4) onto the tray (1) provided by the tray conveying system,
wherein the loading device (30) has a load acquisition system (52) for acquiring load dimensions, a tray acquisition system (53) for acquiring the loading width (d1, d2) of the tray (1) and a computer system (51), and
wherein the load acquisition system (52), the tray acquisition system (53), the computer system (51), the control device (50) and the position changing device (35) are configured to perform the steps of a computer-implemented method for controlling (60) a position changing device (35) for changing a pose of the load (4) and for the situational positioning of the load (4) by the control device (50) comprising:
acquiring a loading width (d1, d2) of the tray (1) by a tray acquisition system (53) and transferring the acquired loading width (d1, d2) from the tray acquisition system (53) to the computer system (51),
comparing the load dimensions with the loading width (d1, d2) by the computer system (51),
determining, by the computer system (51), a loading pose for the load (4) which is to be placed on the tray (1), wherein the loading pose is determined using the load dimensions in such a way that a rotation of the load (4) on the tray (1) is restricted by the loading width (d1, d2),
generating, by the computer system (51), a control specification (59) for controlling (60) the position changing device (35) to bring the load (4) into the loading pose, and
transferring the control specification (59) from the computer system (51) to the control device (50) and control of the position changing device (35) according to the control specification (59) by the control device (50).

46. The loading device (30) according to claim 45, wherein the tray (1) comprises a second receiving compartment which forms a second loading plane (303b) at a second height level and is designed with a wider loading width (d2) with respect to the loading width (d1) of the first receiving compartment.

47. The loading device (30) according to claim 45, wherein the position changing device (35) comprises an alignment device (43) for positioning the load (4) on the load conveying system.

48. The loading device (30) according to claim 45, wherein the position changing device (35) comprises a rotation device (38) and/or a tilting device (36) for changing a pose of the load (4).

49. The loading device (30) according to claim 45, wherein the load acquisition system (52) comprises a measuring device (34) with a sensor which is arranged along the conveying system for transporting the load (4) and is configured to acquire the load dimensions.

50. The loading device (30) according to claim 45, wherein the load conveying system comprises a grouping device (41) for creating a load group from several loads (4).

51. An order-picking system (61) for storing and picking loads (4) comprising
a plurality of trays (1) for transporting loads (4) in the order-picking system (61),
a loading device (30) for loading a tray (1) with a load (4) or several loads (4),
an automatically operated tray storage (64) for storing loads (4) on the trays (1),
a first conveying device between the loading device (30) and the tray storage (64) in order to transport the trays (1) after loading from the loading device (30) to the tray storage (64),
an unloading device (5) for unloading a tray (1) which is loaded with a load (4) or several loads (4),
a second conveying device between the tray storage (64) and the unloading device (5) in order to transport the trays (1) from the tray storage (64) to the unloading device (5), and
an order-picking device (65) for loading an order load carrier with loads (4) which were unloaded from the trays (1) at the unloading device (5),
wherein
the trays (1) are configured according to claim 1.
